(19) United States
(12) Patent Application Publication
(10) Pub. No.: US 2022/0156232 A1
(43) Pub. Date: May 19, 2022

(54) METHOD FOR CONSTRUCTING A DATABASE BASED ON ONTOLOGY, METHOD FOR RESPONDING TO USER QUERY USING THE DATABASE, AND SYSTEM IN WHICH THE METHODS ARE IMPLEMENTED

(71) Applicant: Hyun Joo LEE, Cheonan-si (KR)

(72) Inventor: Hyun Joo LEE, Cheonan-si (KR)

(21) Appl. No.: 17/523,539

(22) Filed: Nov. 10, 2021

(30) Foreign Application Priority Data
Nov. 16, 2020 (KR) 10-2020-0152847

(51) Int. Cl. G06F 16/21

(52) U.S. Cl. CPC G06F 16/21

(57) ABSTRACT

Provided is a method performed by a computing device for constructing a database based on an ontology. The method comprises generating a first-level network representing a relation between core concepts based on a data frame, generating a second-level network by integrating the first-level network with another first-level network, and generating a third-level network that extends a depth of the second-level network by using hierarchical information of the core concepts, wherein the hierarchical information is based on a predetermined ontology.

### CROSS-REFERENCE TO RELATED APPLICATION

This application claims benefit to Korean Patent Application No. 10-2020-0152847 filed on Nov. 16, 2020, in the Korean Intellectual Property Office, the entire content of which are incorporated herein by reference.

### BACKGROUND

### 1. Field

The present invention relates to a method of constructing a database based on an ontology and responding to a user query using the constructed database, and a system in which such a method is implemented.

### 2. Description of the Related Art

In modern society, global problems are multidimensional and complex, and its phenomenon is expressed by the interaction between various factors. For example, water-related problems such as water scarcity and water pollution are influenced by various factors such as industrialization, agriculture, population growth, and affect other factors such as health, environment, and urban policy.

Factors that affect global problems are very diverse and the relationships between them are too complex, so there is a limit to human analysis or understanding of the interaction based only on the existing simple database system.

The existing database system can collect and store various data, and retrieve and provide the stored data when a user requests it, but this only simply presents the content contained in individual data. It is not possible to provide extended information by inferring and analyzing the relationship between data.

### SUMMARY

A technical problem to be solved through some embodiments of the present disclosure is to provide a database construction method based on an ontology that infers an embedded relation between collected data to analyze a global problem and turns it into a database, and a system, in which the method is implemented.

Another technical problem to be solved through some embodiments of the present disclosure is to provide a method that uses an ontology-based database to respond to a user query on a global problem, and a system, in which the method is implemented.

The technical problems of the present disclosure are not limited to the technical problems mentioned above, and other technical problems not mentioned will be clearly understood by those skilled in the art from the following description.

According to a method performed by a computing device for constructing a database based on an ontology comprises: generating a first-level network representing a relation between core concepts based on a data frame, generating a second-level network by integrating the first-level network with another first-level network and generating a third-level network that extends a depth of the second-level network by using hierarchical information of the core concepts, wherein the hierarchical information is based on a predetermined ontology.

According to an embodiment, wherein generating the first-level network comprises, extracting a first core concept and a second core concept from an item of the data frame, calculating node values of the first core concept and the second core concept, calculating an edge value between the first core concept and the second core concept and generating the first-level network based on the node values and the edge value.

According to an embodiment, wherein the node values indicate importance of the first core concept and the second core concept within the item.

According to an embodiment, wherein the edge value indicates a degree of relevancy between the first core concept and the second core concept within the item.

According to an embodiment, wherein generating the second-level network comprises, integrating the first-level network and another first-level network based on relevancy between a first core concept of the first-level network and a third core concept of another first-level network.

According to an embodiment, wherein generating the third-level network comprises, identifying an upper core concept of a first core concept among the core concepts by using the hierarchical information, determining a node value of the upper core concept based on a node value of the first core concept and determining an edge value corresponding to the upper core concept based on an edge value between the first core concept and a second core concept.

According to an embodiment, wherein determining a node value of the upper core concept comprises, assigning a node value of the first core concept as a node value of the upper core concept.

According to an embodiment, wherein determining a node value of the upper core concept further comprises, determining, in response to a plurality of node values being assigned to the upper core concept by depth extending the second-level network, a result of summing the plurality of node values as a node value of the upper core concept.

According to an embodiment, wherein determining an edge value corresponding to the upper core concept comprises, assigning an edge value between the first core concept and the second core concept as an edge value between the upper core concept and a third core concept.

According to an embodiment, wherein determining an edge value corresponding to the upper core concept further comprises, determining, in response to a plurality of edge values being assigned between the upper core concept and the third core concept by depth extending the second-level network, a result of summing the plurality of edge values as an edge value between the upper core concept and the third core concept.

According to an embodiment, wherein generating the third-level network comprises, identifying a lower core concept of a first core concept among the core concepts by using the hierarchical information, determining a node value of the lower core concept based on a node value of the first core concept and determining an edge value corresponding to the lower core concept based on an edge value between the first core concept and the second core concept.

According to an embodiment, wherein determining a node value of the lower core concept comprises, dividing a node value of the first core concept and assigning it as a node value of the lower core concept.

According to an embodiment, wherein determining a node value of the lower core concept further comprises, determining, in response to one or more node values being assigned to the lower core concept by depth extending the second-level network, a node value of the lower core concept by summing the one or more node values.

According to an embodiment, wherein determining an edge value corresponding to the lower core concept comprises, dividing an edge value between the first core concept and the second core concept and assigning it as an edge value between the lower core concept and a fourth core concept.

According to an embodiment, further comprises, updating the third-level network by using embedded relation information of a first core concept among the core concepts.

According to an embodiment, further comprises, generating a fourth-level network by connecting indicator information of the core concepts to the second-level network or the third-level network.

According to an embodiment, further comprises, generating an indicator network representing indicator information of the core concepts.

According to another aspect of the present disclosure, A system for constructing a database based on an ontology comprising: a processor, a memory for loading a computer program executed by the processor and a storage for storing the computer program, wherein the computer program comprises instructions for performing operations comprising, generating a first-level network representing a relation between core concepts based on a data frame, generating a second-level network by integrating the first-level network with another first-level network and generating a third-level network that extends a depth of the second-level network by using hierarchical information of the core concepts, wherein the hierarchical information is based on a predetermined ontology.

According to another aspect of the present disclosure, a method performed by a computer device for responding to a user query comprising: receiving a query from a user, determining a cuboid including one or more keywords based on the query, retrieving information corresponding to the query from a database with reference to the cuboid, analyzing relevancy between core concepts by using the retrieved information and providing a response to the query based on the analyzed result, wherein the core concepts are elements constituting a hierarchical structure of a predetermined ontology, wherein the database is constructed based on the core concepts and the hierarchical structure.

According to an embodiment, wherein the keyword comprises a category keyword for distinguishing information in the database.

According to an embodiment, wherein retrieving information corresponding to the query comprises, identifying a first core concept with reference to the cuboid and retrieving other core concepts located within a search distance from the first core concept.

According to an embodiment, wherein retrieving information corresponding to the query further comprises, retrieving indicator information corresponding to the first core concept and the other core concepts.

According to an embodiment, wherein analyzing relevancy between the core concepts comprises, analyzing correlation between the core concepts based on a domain and a dimension of the core concepts.

According to an embodiment, wherein the domain and the dimension of the core concepts are defined based on the ontology.

According to an embodiment, wherein providing a response to the query comprises, generating a response sentence to the query based on morphemes representing the core concepts.

According to an embodiment, wherein the response sentence is generated further based on a domain of the core concepts, a dimension of the core concepts, relation between the core concepts, or indicator information of the core concepts.

According to another aspect of the present disclosure, a system for responding to a user query comprising: a processor, a memory for loading a computer program executed by the processor and a storage for storing the computer program, wherein the computer program comprises instructions for performing operations comprising, receiving a query from a user, determining a cuboid including one or more keywords based on the query, retrieving information corresponding to the query from a database with reference to the cuboid, analyzing relevancy between core concepts by using the retrieved information and providing a response to the query based on the analyzed result, wherein the core concepts are elements constituting a hierarchical structure of a predetermined ontology, wherein the database is constructed based on the core concepts and the hierarchical structure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram showing an exemplary form of an ontology referenced in some embodiments of the present disclosure;

FIGS. 2 to 7 are diagrams illustrating exemplary forms of data frames referenced in some embodiments of the present disclosure;

FIG. 8 is a flowchart illustrating a method of constructing a database based on an ontology according to an embodiment of the present disclosure;

FIG. 9 is a flowchart illustrating step S110 of FIG. 8 in more detail;

FIG. 10 is a diagram exemplarily illustrating a method of generating a first-level network for each individual item using a basic data frame;

FIG. 11 is a diagram for describing an exemplary method of calculating a node value of each node and an edge value between nodes in the first-level network generation;

FIG. 12 is a diagram illustrating an exemplary form of a first-level network generated according to the method described in FIG. 11;

FIG. 13 is a diagram illustrating an embodiment of generating a second-level network by integrating a plurality of first-level networks;

FIG. 14 is a diagram illustrating another embodiment of generating a second-level network by integrating a plurality of first-level networks;

FIG. 15 is a diagram conceptually illustrating a method of generating a third-level network by extending the depth of a second-level network;

FIG. 16 is a flowchart illustrating an embodiment, in which step S130 of FIG. 8 is further detailed;

FIG. 17 is a diagram for further describing step S131 of FIG. 16;

FIG. 18 is a flowchart illustrating an embodiment, in which step S132 of FIG. 16 is further detailed;

FIG. 19 is a diagram for further describing the embodiment of FIG. 18;

FIG. 20 is a flowchart illustrating an embodiment, in which step S133 of FIG. 16 is further detailed;

FIG. 21 is a diagram for further describing the embodiment of FIG. 20;

FIG. 22 is a flowchart illustrating another embodiment, in which step S130 of FIG. 8 is further detailed;

FIG. 23 is a diagram for further describing step S135 of FIG. 22;

FIG. 24 is a flowchart illustrating an embodiment, in which step S136 of FIG. 22 is further detailed;

FIG. 25 is a diagram for further describing the embodiment of FIG. 24;

FIG. 26 is a flowchart illustrating an embodiment, in which step S137 of FIG. 22 is further detailed;

FIG. 27 is a diagram for further describing the embodiment of FIG. 26;

FIG. 28 is a flowchart illustrating a method of constructing a database based on an ontology according to another embodiment of the present disclosure;

FIG. 29 is a diagram for further describing step S140 of FIG. 28;

FIG. 30 is a flowchart illustrating a method of constructing a database based on an ontology according to another embodiment of the present disclosure;

FIG. 31 is a diagram illustrating an exemplary form of indicator information mentioned in the embodiment of FIG. 30;

FIGS. 32 and 33 are diagrams for further describing step S160 of FIG. 30;

FIG. 34 is a flowchart illustrating a method for responding to a user query according to an embodiment of the present disclosure;

FIG. 35 is a diagram for further describing steps S210 and S220 of FIG. 34;

FIG. 36 is a flowchart illustrating an embodiment, in which step S230 of FIG. 34 is further detailed;

FIGS. 37 and 38 are views for further describing the embodiment of FIG. 36;

FIG. 39 is a view for describing a specific example of outputting a response to a user query in the form of a sentence; and

FIG. 40 is a hardware configuration diagram of an exemplary computing device, in which various embodiments of the present disclosure may be implemented.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present inventive concept, when it is determined that the detailed description of the related well-known configuration or function may obscure the gist of the present inventive concept, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present inventive concept will be described in detail with reference to the accompanying drawings.

Ontology for Structuring Global Problems

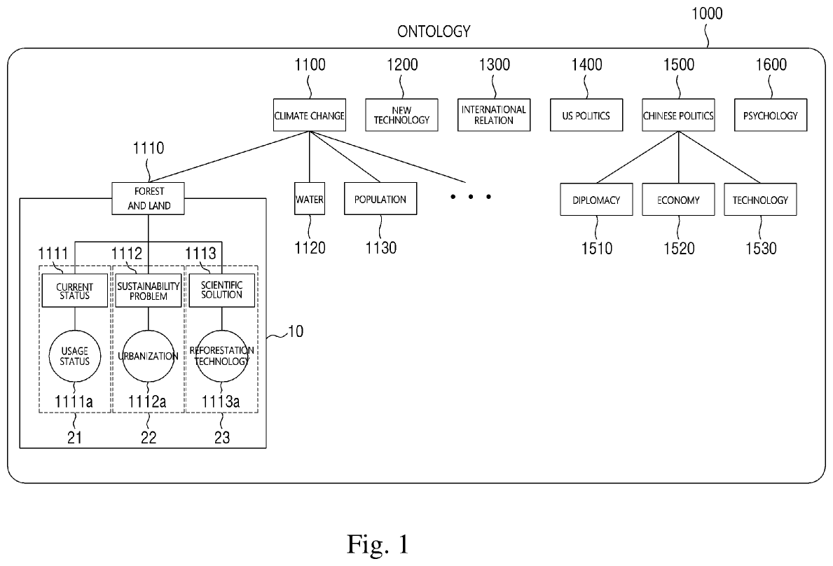

FIG. 1 is a conceptual diagram illustrating an exemplary form of an ontology referenced in some embodiments of the present disclosure.

Ontology 1000 refers to a model, in which elements related to global problems are structured in a tree form according to fields, domains, dimensions, etc. In the present disclosure, individual elements on the ontology 1000 related to global problems are defined as core concepts 1110, 1120, 1130, 1510, 1520, 1530, 1111, 1112, 1113, 1111a, 1112a, 1113a.

The ontology 1000 includes a plurality of fields as the largest category. Taking FIG. 1 as an example, the ontology 1000 includes six fields of climate change 1100, new technology 1200, international relations 1300, US politics 1400, Chinese politics 1500, and psychology 1600.

In each field 1100, 1200, 1300, 1400, 1500, 1600, several core concepts belonging to the field exist in a tree structure. For example, the climate change 1100 includes forest and land 1110, water 1120, and population 1130 as core concepts related to climate change, and forest and land 1110 further includes the current status 1111, sustainability problems 1112, scientific solutions 1113 as a lower core concept. Further, the current status 1111 includes the usage status 1111a, the sustainability problems 1112 includes urbanization 1112a, and scientific solutions 1113 includes reforestation technology 1113a as a lower core concept, respectively.

In FIG. 1, a detailed tree structure is shown only for climate change 1100 for the sake of simplicity of description, but in other fields 1200, 1300, 1400, 1500, 1600, several core concepts have a tree structure with each other within the field. For example, in the case of Chinese politics 1500, diplomacy 1510, economy 1520, technology 1530, etc. may exist as related core concepts, and from them, lower core concepts such as the current status, sustainability problems, and scientific solutions may be derived while having a tree structure.

In the ontology 1000, the core concepts of each field 1100, 1200, 1300, 1400, 1500, and 1600 are divided into a domain and a dimension. The domain is a category corresponding to a sub-topic that categorizes the core concepts belonging to each field 1100, 1200, 1300, 1400, 1500, 1600. For example, in the field of climate change 1100, based on the uppermost core concepts of forest and land 1110, water 1120, and population 1130, core concepts related thereto each constitute a domain. Referring to the example of FIG. 1, a forest and land 1110 and lower core concepts 1111, 1112, 1113, 1111a, 1112a, and 1113a derived therefrom constitute one forest and land domain.

The dimension is a criterion for secondarily classifying each core concept within one domain, and may indicate a topic related to the corresponding domain. For example, a dimension may refer to a specific topic, such as ‘current status,’ ‘sustainability problem,’ or ‘scientific solution,’ and core concepts within a domain may be classified into specific dimensions depending on which topic they relate to.

For example, referring to FIG. 1, the forest and land domain 1110 includes a current status dimension 21, a sustainability problem dimension 22, and a scientific solution dimension 23, and the current status dimension 21 includes core concepts 1111, 1111a related to the current status of forests and land, such as the usage status 1111a, and the sustainability problem dimension 22 includes core concepts 1112, 1112a related to problems which affect the sustainability of forests and land, such as urbanization 1112a, and the scientific solution dimension 23 includes core concepts 1113, 1113a related to scientific solutions that can solve problems of forests and land, such as reforestation technology 1113a.

A dimension may be a unique criterion applicable only to a specific domain, or it may be a universal criterion applicable in common to several domains. For example, ‘current status,’ ‘sustainability problem,’ and ‘scientific solution,’ which are the dimensions of forest and land domains 10, may be commonly applied to the domains of diplomacy 1510, economy 1520, and technology 1530 in the field of Chinese politics 1500, and used as a criterion for classifying core concepts in the corresponding domain.

Based on the basic structure of the ontology 1000, it is possible to obtain important information related to the core concept only by the position of the core concept in the tree structure. For example, in the case of urbanization 1112a, through the position on the ontology 1000, the information that ‘urbanization 1112a is a core concept belonging to the field of climate change 1100, in particular, it is an issue belonging to the forest and land domain 10, and related to the forest and land 1110 and its sustainability problem 1112, which are the upper core concepts,’ can be extracted.

Fields 1100, 1200, 1300, 1400, 1500, 1600 and core concepts 1110, 1120, 1130, 1510, 1520, 1530, 1111, 1112, 1113, 1111a, 1112a, 1113a constituting the ontology 1000, and its tree structure may be predetermined. This may be determined directly by a person, may be determined by using a computer as an auxiliary means (Computer-Aided), or may be determined by using artificial intelligence software.

Hereinafter, specific embodiments of a method of constructing a database related to a global problem based on the ontology 10000 structure and responding to a user query through this will be described. In the following embodiments, when the subject of a specific action is not specified, it is assumed that the subject is a system, in which a database construction method based on ontology is implemented, or a user query response system using the same. In this case, the system, in which the database constructing method is implemented, or the user query response system may be a computing device including a machine learning- or deep learning-based artificial intelligence model.

Data Frame Structure

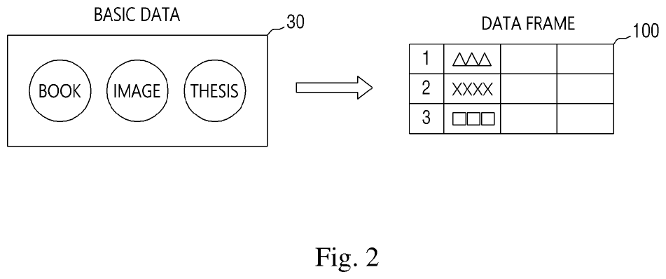

FIG. 2 is a diagram conceptually illustrating a method of constructing a data frame based on basic data. In the present disclosure, when various basic data 30 that can be information sources such as books, images, thesis, journals, and newspapers are collected, a data frame 100 for database construction is generated based on this.

Specifically, when the basic data 30 is collected, it is determined whether the collected basic data 30 includes content related to the core concept of the ontology. If content related to a core concept of an ontology is included, information related to the core concept is extracted from the content, and generated or converted into the data frame 100 together with the core concept.

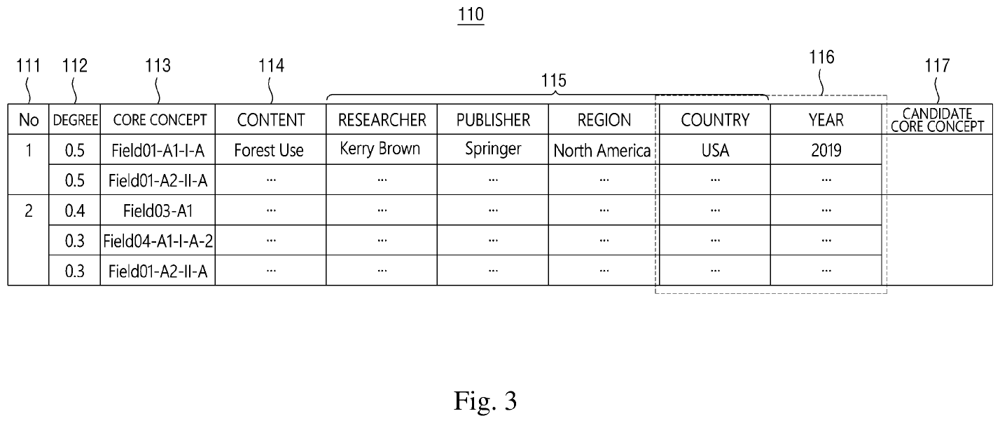

An example of such a data frame 100 is shown in FIG. 3. The table 110 of FIG. 3 organizes information extracted from basic data, and core concepts and related information are arranged in the form of a table. The form shown in FIG. 3 is called a basic data frame 110 (hereinafter ‘BDF’) among the data frames.

In the BDF 110, core concepts and related information extracted from basic data are sorted and organized in units of items. An item refers to a unit of information that can group organic relationships between core concepts among the contents of basic data into a single mass. For example, it is assumed that the basic data contains three chapters, of which the first chapter describes the core concepts of A and B, the second chapter describes the core concept of C, and the third chapter describes core concepts of A, D, and E.

At this time, if the first chapter is related to ‘breakfast,’ the second chapter is related to ‘exercise,’ and the third chapter is related to ‘smoking,’ the contents of each chapter are distinguished from each other, so they are considered as each item. Thus, in the BDF 110, two core concepts of A and B and related information are organized for the ‘breakfast’ item, one core concept of C and related information are organized for the ‘exercise’ item, and the three core concepts of A, D, and E and related information are organized for the ‘smoking’ item.

On the other hand, if the first chapter is related to ‘breakfast menu,’ the second chapter is related to ‘the usefulness of breakfast,’ and the third chapter is related to ‘smoking,’ it is considered that the first and second chapters constitute one ‘breakfast’ item. Thus, in the BDF 110, three core concepts of A, B and C, and related information are organized for the ‘breakfast’ item, and the three core concepts of A, D and E, and related information are organized for the ‘smoking’ item.

In one embodiment, the BDF 110 may include various fields such as NO 111, degree 112, core concept 113, content 114, various indicators 115, category 116, and candidates of core concept 117.

NO 111 is a field indicating the number of the item and may be used as an ID (Identification) of the item. For example, two item numbers are indicated in the BDF 110 of FIG. 3, which may mean the first item and the second item, respectively.

The degree field 112 is information indicating the importance occupied by the corresponding core concept in the item. In FIG. 3, the first item includes two core concepts, and the degree of each core concept is equal to 0.5. This means that the importance occupied by each core concept in the first item is the same. As another example, referring to the second item of FIG. 3, three core concepts are included, among which the degree of the Field03-A1 core concept is 0.4, which is larger than other core concepts. This means that the importance of the Field03-A1 core concept in the second item is relatively higher.

The core concept field 113 is a field indicating a core concept. Here, the core concept is expressed as the position of the core concept within the tree structure of the ontology. For example, ‘Field01-A1’ means a core concept named ‘A1’ among the core concepts with a depth of 0 in the tree structure of the first field (Field01). Similarly, ‘Field01-A1-I’ is a lower core concept of ‘Field01-A1’ among the core concepts with a depth of 1 in the tree structure of the first field (Field01), and means the core concept named ‘I.’ Similarly, ‘Field01-A1-I-A’ is a lower core concept of ‘Field01-A1-I’ among the core concepts with a depth of 2 in the tree structure of the first field (Field01) and means the core concept named ‘A.’ According to this method of naming core concepts, there is an advantage in that the structural position of the core concept on the ontology can be inferred just by looking at the name of the core concept.

Meanwhile, here, the depth means the distance away from the root or the uppermost core concept in the tree structure. If the depth is ‘0,’ it means the distance from the root is ‘0,’ that is, the uppermost core concept closest to the root, and if the depth is ‘1,’ it means that the distance from the root is ‘1,’ that is, the next uppermost core concept that is one level away from the root. In general, the depth ‘K’ may mean that the distance from the root is ‘K,’ and it is a core concept that has descended from the uppermost by K levels. Taking the tree structure of FIG. 1 as an example, the forest and land 1110 is a core concept with the depth of ‘0’ in the climate change field 1100, and the current status 1111 derived from the forest and land 1110 is a core concept with the depth of ‘1’ in the climate change field 1100, and the usage status 1111a derived from the current status 1111 is a core concept with a depth of ‘2’ in the climate change field 1100.

In the content field 114, the linguistic meaning of the corresponding core concept is described. For example, while the previously described core concept field 113 names the core concept as a structural position on the ontology, the content field 114 names the core concept as the original linguistic meaning. For example, if there is a core concept of ‘Forest Use’ in the place of Field01-A1-II-B-1 in the ontology, ‘Field01-A1-II-B-1’ is described in the core concept field 132 and ‘Forest Use’ is described in the content field 114.

In the indicator field 115, information related to a core concept is described. The indicator field 115 may include various information items. For example, it is assumed that the basic data, from which core concepts are extracted, is a thesis. In this case, information on a researcher, publisher, publication region, and publication country of the thesis may be described in the field 115 as an indicator of a core concept.

The category field 116 is an item indicating information for classifying the extracted core concept. For example, if it is desired to separately classify only information related to 2019 among core concepts, only those whose year is ‘2019’ may be separately classified by referring to year information in the category field 116.

Meanwhile, the indicator field 115 and the category field 116 may overlap with each other. The indicator field 115 and the category field 116 are set independently of each other, and some items may be redundantly included in the indicator field 115 and the category field 116. For example, in FIG. 3, the country item may be an item of the indicator field 115 as well as an item of the category field 116.

The candidate core concept 117 is not a core concept on the ontology, but is an item that describes an element that occupies a major importance in the item. For example, if ‘allergy’ is mentioned several times as the main content in the first item but does not correspond to the core concept of the ontology, ‘allergy’ may be described in the candidate core concept 117 field. This is to refer to it for the selection of core concepts to be added to the ontology when the ontology is updated later. For example, a concept more frequently described in the candidate core concept 117 field may be preferentially added as a new core concept of the ontology.

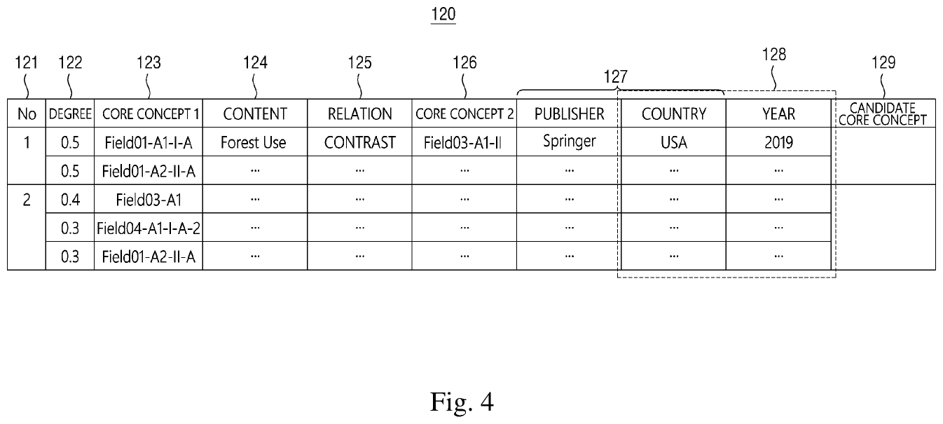

FIG. 4 is a diagram illustrating another embodiment of the BDF. In the BDF 120 of FIG. 4, relation information between the core concept extracted from the basic data and other core concepts is further described. Referring to FIG. 4, BDF 120 includes NO 121, degree 122, core concept 1 123, content 124, various indicators 127, categories 128, and candidate core concepts 129 fields, and additionally includes the relation 125 and core concept 2 126 fields.

Since NO 121, degree 122, core concept 1 123, content 124, various indicators 127, category 128, and candidate core concept 129 fields are substantially the same as those described in FIG. 3, related descriptions are omitted here to avoid duplication of descriptions.

The core concept 2 field 126 and the relation field 125 are used to indicate the relevancy between the core concept extracted from the basic data and other core concepts. For example, when it is determined that the core concept ‘Field01-A1-I-A’ is extracted from the first item of the basic data, and there is a ‘contrast’ relation between the core concept ‘Field01-A1-I-A’ and another core concept ‘Field03-A1-II’ through the first item, as shown in FIG. 4, ‘contrast’ is described in the relation field 125 of the BDF 120 and another core concept ‘Field03-A1-II’ having the contrast relation is described in the core concept 2 field 126.

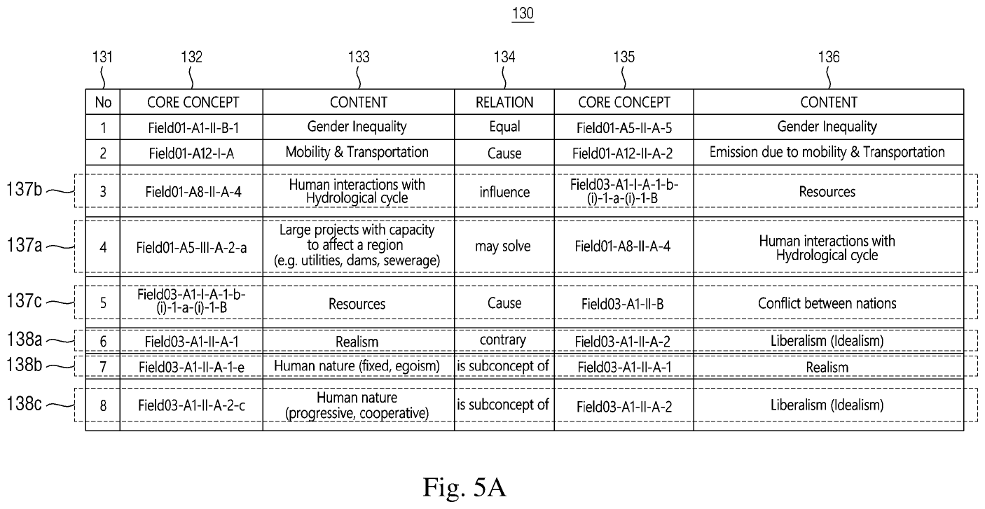

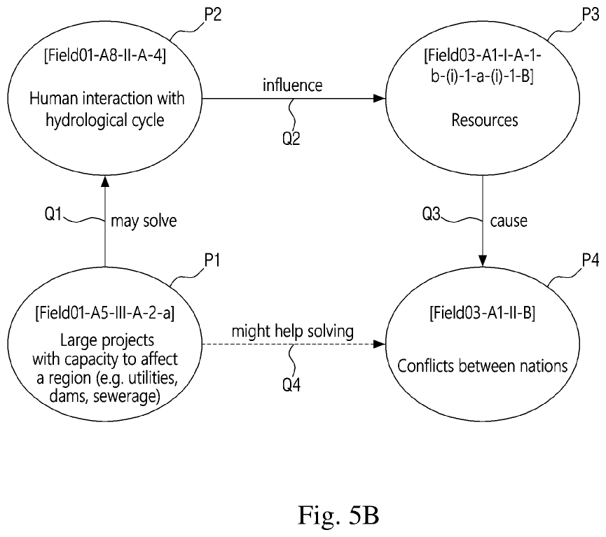

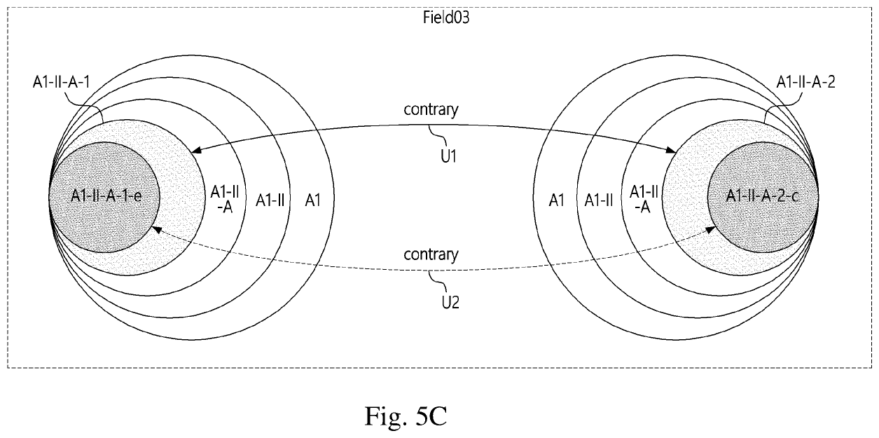

FIGS. 5A to 5D are diagrams for describing embedded relation information between core concepts as another example of a data frame.

FIG. 5A is a diagram illustrating an example of the core concept embedded relation information 130, and the embedded relation information 130 includes NO 131, core concept 132, content 133, relation 134, core concept 135, and content 136 fields.

The embedded relation information 130 organizes information that can be naturally inferred by inferring the intrinsic meaning between core concepts belonging to the ontology even if it is not directly specified in the basic data.

For example, if ‘Gender Inequality’ is located in common in the ‘Field01-A1-II-B-1’ and ‘Field01-A5-II-A-5’ positions of the ontology, that is, the same core concept is redundantly included in other positions in the ontology, even if the content that the above two core concepts are the same is not explicitly specified in the basic data, it can be seen that the ‘Field01-A1-II-B-1’ core concept and the ‘Field01-A5-II-A-5’ core concept are the same as each other from the embedded meaning of their linguistic meaning.

As another example, in the case that ‘Mobility & Transportation’ is located in the ‘Field01-A12-I-A’ position of the ontology, and ‘Emission due to mobility & Transportation’ is located in the ‘Field01-A12-II-A-2’ position of the ontology, similar to the previous case, even if the relation between the two core concepts, ‘Mobility & Transportation’ and ‘Emission due to mobility & Transportation,’ is not directly specified in the basic data, from the embedded meaning of the linguistic meaning, it can be inferred that ‘Field01-A12-I-A’ core concept has a relation that causes ‘Field01-A12-II-A-2’ core concept.

As such, the information inferred from the embedded meaning of the core concepts is organized as the embedded relation information 130. The embedded relation information 130 may be generated by collecting various information sources such as external web pages, documents, and video clips, extracting the embedded relation between core concepts from them, and processing them in the form of a table shown in FIG. 5A. Alternatively, the embedded relation information 130 may be generated by secondarily inferring a relation between core concepts based on the existing embedded relation information stored in the table form.

Extracting the relation between the core concepts from the information source and processing it in the form of a table, or secondary inferring the relation between the core concepts based on the existing embedded relation information can be performed through artificial intelligence models based on machine learning or deep learning.

Meanwhile, the embedded relation information 130 may be indirectly inferred using two or more embedded relations.

For example, in the fourth information 137a among the embedded relation information 130, it is indicated that the core concept ‘Field01-A8-II-A-4’ may be solved through the core concept ‘Field01-A5-HI-A-2-a.’ In addition, in the third information 137b among the embedded relation information 130, it is indicated that the core concept ‘Field01-A8-II-A-4’ influences the core concept ‘Field03-A1-I-A-1-b-(i)-1-a-(i)-1-B,’ and in the 5th information 137c among the embedded relation information 130, it is indicated that the core concept ‘Field03-A1-IA-1-b-(i)- 1-a-(i)-1-B’ causes the core concept ‘Field03-A1-II-B.’

That is, looking at the three embedded relation 137a, 137b, and 137c, it can be seen that each of the embedded relations 137a, 137b, and 137c are connected with each other with relevancy, and a new embedded relation can be indirectly inferred from this. This will be further described with reference to FIG. 5B.

Referring to FIG. 5B, a network representing the three embedded relations described above is shown. The core concept ‘Field01-A5-III-A-2-a’(P1) can solve the core concept ‘Field01-A8-II-A-4’ (P2) (Q1), the core concept ‘Field01-A8-II-A-4’(P2) influences the core concept ‘Field03-A1-IA-1-b-(i)-1-a-(i)-1-B’(P3) (Q2), and the core concept ‘Field03-A1-IA-1-b-(i)-1-a-(i)-1-B’(P3) causes the core concept ‘Field03-A1-II-B’ (P4) (Q3).

According to this, the core concept ‘Field01-A5-III-A-2-a’(P1) and the core concept ‘Field03-A1-II-B’(P4) are not directly related to each other, but are indirectly related through three embedded relations information (Q1, Q2, Q3). That is, through the sequential embedded relation information (Q1, Q2, Q3) via the other two nodes (P2, P3), new embedded relation (Q4: ‘might help solving’=may solve+influence+cause) is indirectly inferred between the core concept ‘Field01-A5-III-A-2-a’(P1) and the core concept ‘Field03-A1-II-B’(P4).

The embedded relation information derived through such indirect inference may be newly added to the existing embedded relation information 130.

The method of indirectly inferring an embedded relation using the existing embedded relation information 130 described so far may be performed by an artificial intelligence model using machine learning or deep learning.

Meanwhile, the embedded relation information 130 may be indirectly inferred using a hierarchical relation between core concepts.

Returning back to FIG. 5A, in the sixth information 138a of the embedded relation information 130, it is indicated that the core concept ‘Field03-A1-II-A-1’ and the core concept ‘Field03-A1-II-A-2’ are contrary to each other. In addition, in the seventh information 138b of the embedded relation information 130, it is indicated that the core concept ‘Field03-A1-II-A-1-e’ is a lower core concept (subconcept) of the core concept ‘Field03-A1-II-A-1,’ and in the eighth information 138c among the embedded relation information 130, it is indicated that the core concept ‘Field03-A1-II-A-2-c’ is a lower core concept (subconcept) of the core concept ‘Field03-A1-II-A-2.’

Based on the three embedded relations 138a, 138b, and 138c, since the core concept ‘Field03-A1-II-A-1’ and the core concept ‘Field03-A1-II-A-2’ are contrary to each other, it can be indirectly inferred that there is a contrary relation between the core concept ‘Field03-A1-II-A-1-e’ and the core concept ‘Field03-A1-II-A-2-c’, which are lower core concepts thereof. This will be further described with reference to FIG. 5C.

Referring to FIG. 5C, a network representing the three embedded relations described above is shown. The core concept ‘Field03-A1-II-A-1’ and the core concept ‘Field03-A1-II-A-2’ have contrary relation (U1), and the core concept ‘Field03-A1-II-A-1-e’ is a lower core concept of the core concept ‘Field03-A1-II-A-1’ (shown as inclusion relation), and the core concept ‘Field03-A1-II-A-2-c’ is a lower core concept (subconcept) of the core concept ‘Field03-A1-II-A-2’ (shown as inclusion relation).

According to this, although the core concept ‘Field03-A1-II-A-1-e’ and the core concept ‘Field03-A1-II-A-2-c’ are not directly related to each other, a new embedded relation (U2: contrary) between the core concept ‘Field03-A1-II-A-1-e’ and the core concept ‘Field03-A1-II-A-2-c’ can be indirectly inferred by inheriting the relations between the upper core concepts ‘Field03-A1-II-A-1’ and ‘Field03-A1-II-A-2.’

As before, the embedded relation information derived through such indirect inference may be newly added to the existing embedded relation information 130.

The method of indirectly inferring an embedded relation using a hierarchical relation between core concepts described so far may be performed by an artificial intelligence model using machine learning or deep learning.

Meanwhile, although a method of indirectly inferring an embedded relation using the hierarchical relations 138b and 138c described in the embedded relation information 130 has been described in FIG. 5C, the scope of the present disclosure is not limited thereto. For example, even if the hierarchical relation is not directly described in the embedded relation information 130, the embedded relation between core concepts may be indirectly inferred using the hierarchical information of the ontology. This will be described with reference to FIG. 5D.

An original network derived from the BDF is illustrated on the left side of FIG. 5D. The original network includes the core concept ‘Field03-B1-I’ and the core concept ‘Field03-B1-II’ and shows that the core concept ‘Field03-B1-I’ causes the core concept ‘Field03-B1-II’ (V1). At this time, it is assumed that if depth extension (or depth combination) is made for the core concept ‘Field03-B1-I’ and the core concept ‘Field03-B1-II’ with reference to the hierarchical information of the ontology, as shown on the right side of FIG. 5D, ‘Field03-B1-I-a’, which is a lower core concept of ‘Field03-B1-I,’ and ‘Field03-B1-II-b,’ which is a lower core concept of the core concept ‘Field03-B1-II’, are derived.

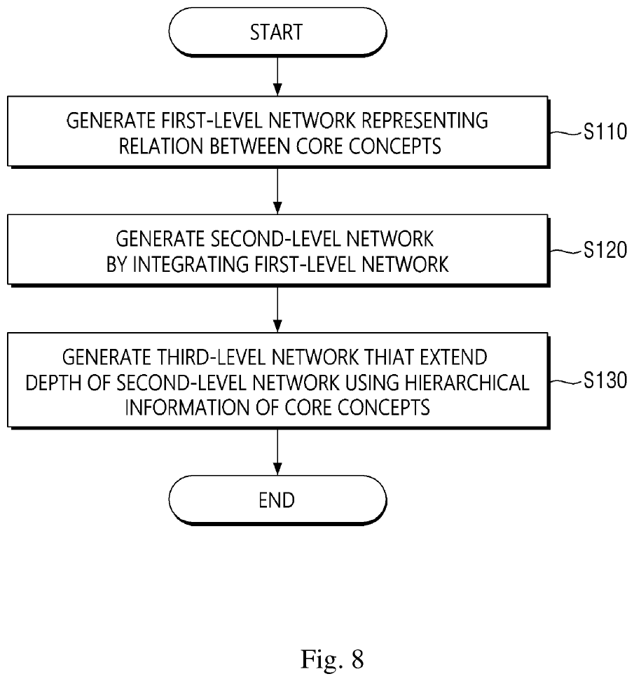

Here, the depth extension (or depth combination) is to derive an upper or lower core concept from the core concept of the original network according to the hierarchical information of the ontology. Since the meaning and method of the depth extension will be described in detail from FIG. 8, a description thereto will be omitted here.

The core concept ‘Field03-B1-I-a’ and the core concept ‘Field03-B1-II-b’ are core concepts derived by searching the hierarchical structure on the ontology of the original network through depth extension. The existing embedded relation information 130 does not describe a relations between them. However, since the core concepts (Field03-B1-I-a, Field03-B1-II-b) are derived due to the depth extension, they have upper or lower relation with the core concepts (Field03-B1-I, Field03-B1-11) of the original network. Therefore, the derived core concept ‘Field03-B1-I-a’ and the core concept ‘Field03-B1-II-b’ are not directly related to each other, but the embedded relation (V3: cause) can be indirectly inferred between the core concept ‘Field03-B1-I-a’ and the core concept ‘Field03-B1-II-b’ by inheriting the relation between their upper core concepts ‘Field03-B1-I’ and ‘Field03-B1-H.’

As before, the embedded relation information derived through indirect inference using hierarchical information of the ontology may be newly added to the existing embedded relation information 130.

The method of indirectly inferring the embedded relation using the hierarchical information of the ontology described so far may be performed by an artificial intelligence model using machine learning or deep learning.

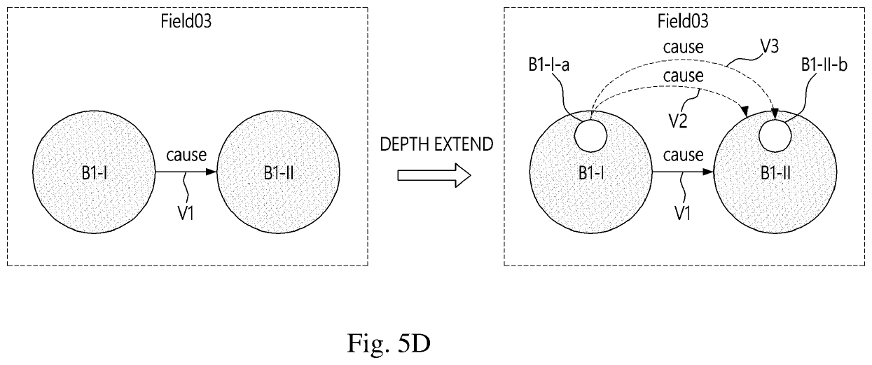

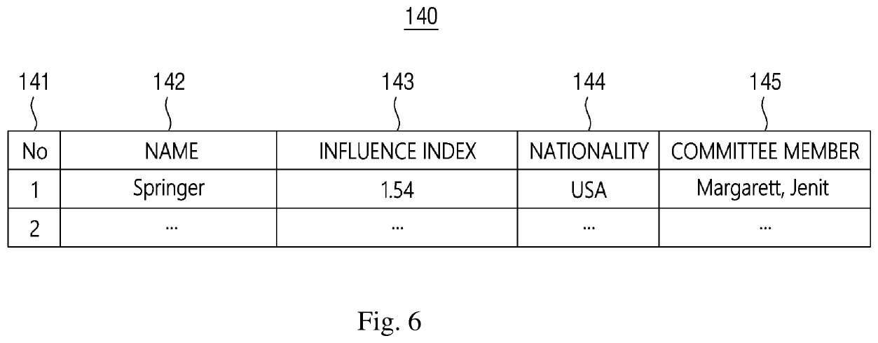

FIG. 6 is a diagram illustrating indicator information 140 as another example of a data frame. The indicator information 140 is a data frame, in which indicators of the BDF are collected and related information is separately processed and organized.

As an embodiment, the indicator information 140 may be individually generated for each type of indicator. FIG. 6 shows an example of the indicator information 140 generated with respect to the ‘publisher’ indicator among various indicators. Referring to FIG. 6, the indicator information 140 may include fields such as NO 141, name 142, influence index 143, nationality 144, and committee member 145.

NO 141 is a field indicating the number of the publisher and may be used as an ID (Identification) of the publisher. The name 142 is a field indicating the name of the publisher. The influence index 143 is a field indicating an index quantifying the overall influence of the publisher. Nationality 144 is a field indicating the nationality of the publisher. Committee member 145 is a field representing committee members of the publisher.

Each field item of the indicator information 140 is also called an indicator attribute. Taking FIG. 6 as an example, the ‘publisher’ indicator has ‘NO,’ ‘name,’ ‘influence index,’ ‘nationality,’ and ‘committee member’ as indicator attributes.

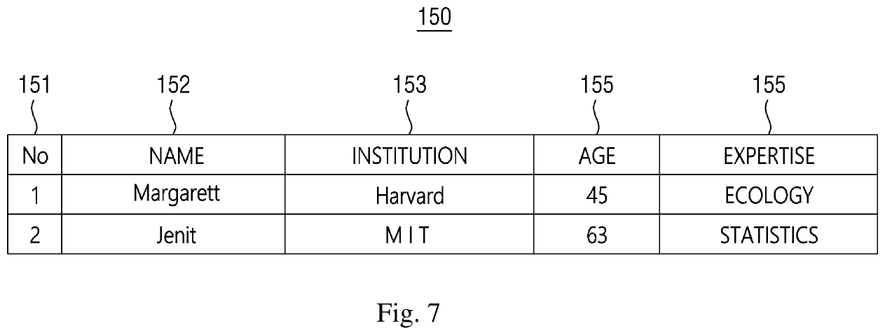

As an embodiment, the indicator attribute may be matched with an attribute table indicating details of the corresponding attribute. An exemplary form of an attribute table is presented in FIG. 7.

Referring to FIG. 7, an attribute table 150 for ‘committee member’ among the indicator attributes of FIG. 6 is exemplarily shown. The attribute table 150 may include fields such as NO 151, name 152, institution 153, age 154, and expertise 155.

The NO 151 is a field indicating the number of each committee member and may be used as an ID (Identification) of the committee member. The name 152 is a field indicating the name of the committee member. The institution 153 is a field indicating the institution or organization to which the committee member belongs. The age 154 is a field indicating the age of the committee member. The expertise 155 is a field indicating the field of expertise of a committee member.

As described above, by additionally matching the attribute table with the indicator attribute, detailed information related to the indicator attribute may be further provided.

Up to now, various data frames used to construct a database based on ontology have been described with reference to various embodiments. Hereinafter, a specific method of constructing a database for global problem analysis using such a data frame will be described.

Database Construction Based on Ontology

FIG. 8 is a flowchart illustrating a method of constructing a database based on an ontology according to an embodiment of the present disclosure.

Referring to FIG. 8, in the database construction method according to the present disclosure, after a first-level network representing the relation between core concepts is generated, a final database is constructed while integrating and extending the network based thereon. In the following description, if the subject of each action is not specified, it is assumed that the subject is a database constructing system, in which the database constructing method according to the present disclosure is implemented. Hereinafter, it will be described with reference to the drawings.

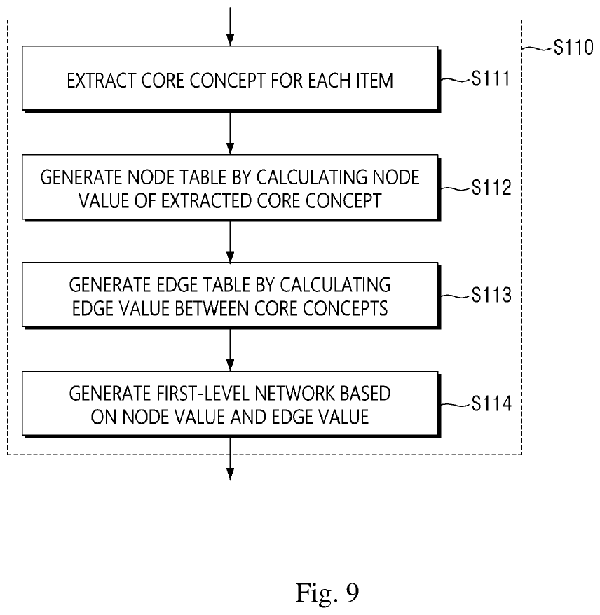

In step S110, a first-level network representing the relation between core concepts is generated from the data frame. Since the first-level network represents the relation between core concepts included in one item based on the item described in the BDF, it may also be referred to as a core concept network. A specific embodiment of generating a first-level network will be described later in detail with reference to FIGS. 9 to 12.

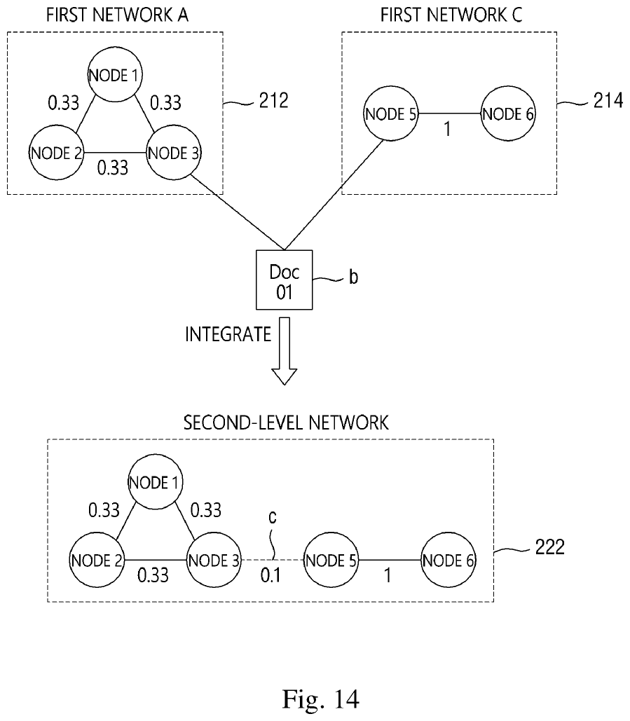

In step S120, the first-level networks generated for each item based on the BDF are integrated with each other to generate a second-level network. In this case, the first-level networks may be integrated into the second-level network through a network projection method. A specific embodiment of the network projection will be described below in detail with reference to FIGS. 13 and 14.

In step S130, the depth of the second-level network is extended by using hierarchical information of core concepts of the second-level network, and as a result, a third-level network is generated. The hierarchical information means hierarchical information between core concepts determined according to the tree structure of the ontology.

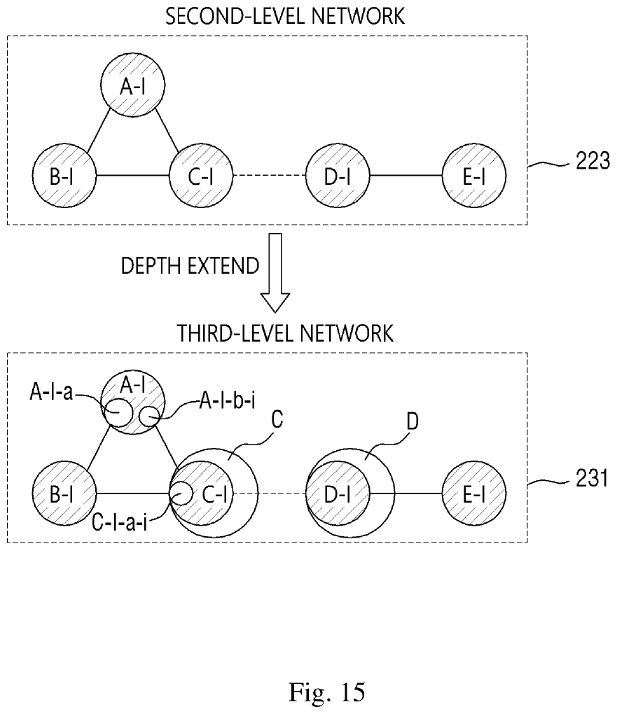

Here, the extension of the depth of the second-level network means that the upper core concept or lower core concept of the original core concept is additionally included in addition to the core concept previously included in the second-level network, which is referred to as the original core concept. A detailed description related to the depth extension of the second-level network will be described later in detail with reference to FIG. 15.

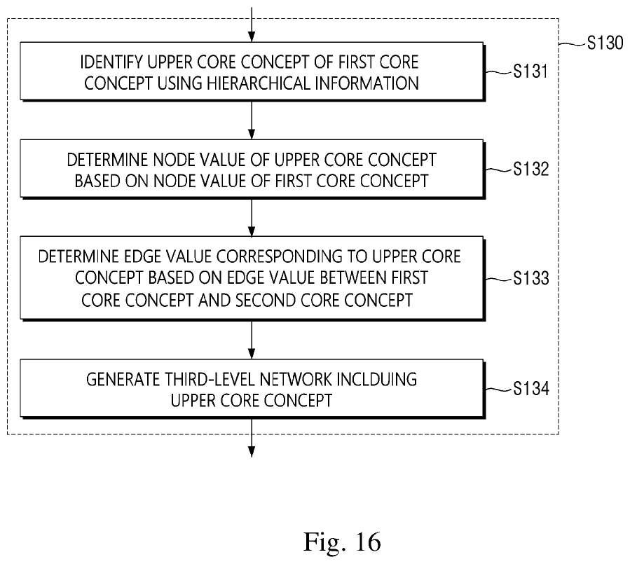

Meanwhile, the depth expansion of the second-level network may be performed using a depth combination method. A specific embodiment related to the depth combination method will be described later in detail with reference to FIGS. 16 to 27.

For a detailed understanding of the steps S110 to S130, the related description will be continued with reference to FIG. 9.

FIG. 9 is a flowchart illustrating step S110 of FIG. 8 in more detail. In FIG. 9, an embodiment of generating a first-level network by calculating node values and edge values of core concepts from BDF is described.

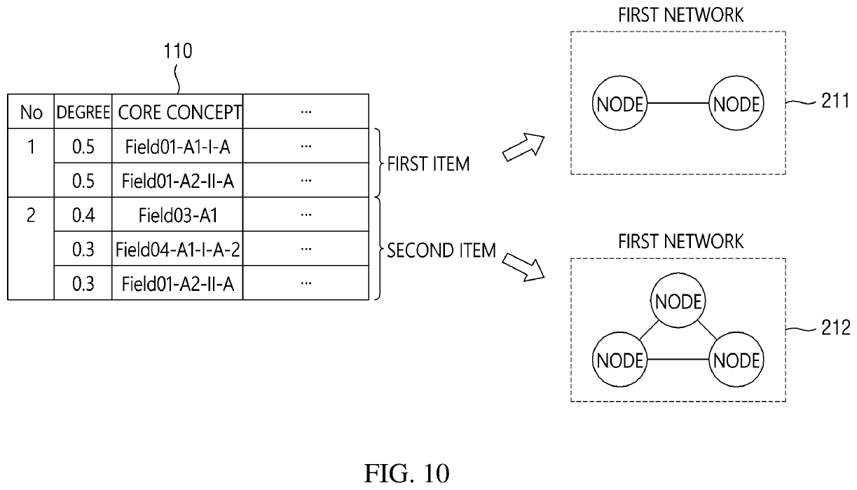

In step S111, a core concept is extracted for each item based on the BDF. For a related description, FIG. 10 is referred to. Looking at the BDF 110 shown on the left side of FIG. 10, the BDF 110 includes two items. Among them, the first item contains two core concepts, and the second item contains three core concepts. The degree displayed next to the core concept indicates the importance that the core concept occupies within the item. For example, in the first item, the core concept of ‘Field01-A1-I-A’ occupies an importance of 0.5.

In this embodiment, the first-level network is generated for each item. That is, one first-level network 211 is generated from the first item, and another first-level network 212 is generated from the second item. To this end, core concepts are extracted for each item from the BDF. The core concepts extracted for each item become nodes of the first-level network. A line connecting nodes to each other indicates a correlation between the nodes, and is referred to as an edge. At this time, it is assumed that there is always an edge between any core concepts of the first-level network. Because they are core concepts included in the same item, it can be considered that there is a basic correlation.

Now, referring back to FIG. 9, in step S112, a node table is generated by calculating the node value of the extracted core concept. Here, the node value means a value indicating the weight or importance of the corresponding core concept in the first-level network. At this time, there may be various ways to obtain the node value of the core concept, but the simplest way is that the degree value of the core concept described in the BDF is determined as the node value.

In step S113, an edge table is generated by calculating edge values between the extracted core concepts. Here, the edge value is a value assigned to an edge connecting each node, and means a value indicating a degree of relation between nodes connected through the corresponding edge. At this time, there may be various ways to obtain the edge values between core concepts, but the simplest way is that when it is assumed that the sum of all edge values in the first-level network is 1, and the number of all edges that can be connected between the extracted core concepts is N, 1/N obtained by dividing 1 by N may be determined as an edge value of each edge.

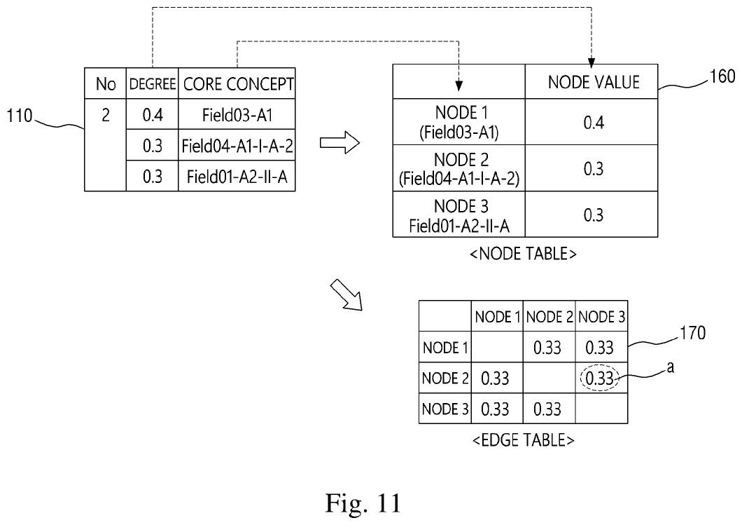

A specific example of steps S112 and S113 will be described with reference to FIG. 11. In FIG. 11, the second item of the BDF 110 includes three core concepts ‘Field03-A1,’ ‘Field-A1-I-A-2,’ and ‘Field01-A2-II-A.’ Therefore, when generating a first-level network based on the second item, node 1 (Field03-A1), node 2 (Field-A1-IA-2), and node 3 (Field01-A2-II-A) are formed according to the number of core concepts, and the number of possible edges is 3 in total: ‘node 1-node 2,’ ‘node 1-node 3,’ and ‘node 2-node 3.’

At this time, when the degree value of the BDF 110 is assigned to each node as a node value, each node value is determined as shown in the node table 160 in the upper right, and when a value obtained by dividing 1, which is the sum of all edge values, by 3, which is the number of all edges, is assigned as the edge value of each edge, each edge value is determined as shown in the edge table 170 on the lower right.

In the edge table 170, each row and column means a node of a first-level network, and a value in a cell where each row and column meets means an edge value between such nodes. For example, in the edge table 170, the value (a) of the cell where the ‘node 2’ row and the ‘node 3’ column meet means the edge value of the edge connecting the node 2 and the node 3.

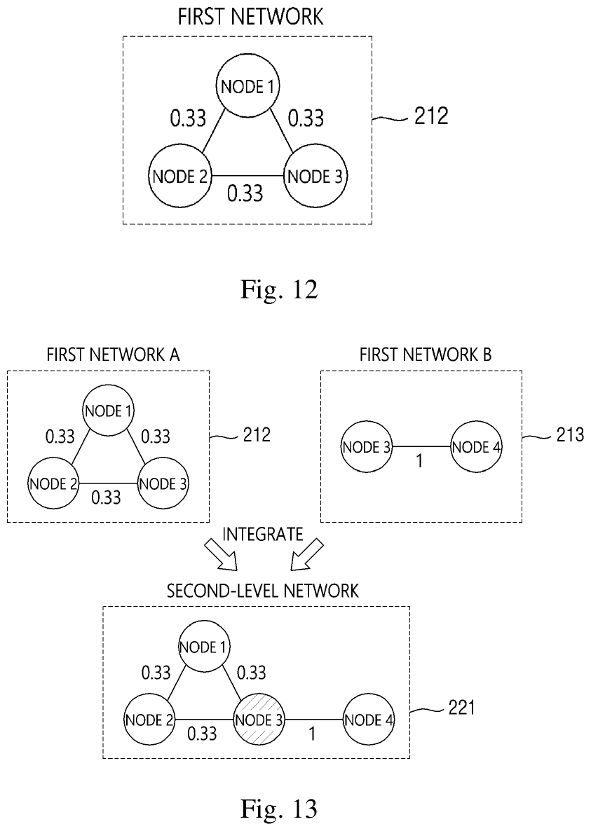

Now, returning to FIG. 9, in step S114, a first-level network is generated based on the previously determined node values and edge values. Referring to FIG. 12, a result of generating the first-level network 212 according to the example of FIG. 11 is shown. Each of the core concepts of the second item is extracted as a node of the first-level network 212 to form node 1, node 2, and node 3, respectively, and their sizes are expressed differently according to node values. For example, in FIG. 12, since the node value of node 1 is 0.4, which is larger than other nodes, the size of node 1 is expressed larger. And, an edge is connected between each node, and an edge value of each edge is expressed as 0.33.

FIGS. 13 and 14 are diagrams for further describing step S120 of FIG. 8, and show embodiments of generating a second-level network by integrating the first-level networks. Among them, FIG. 13 shows an embodiment, in which the first-level networks are integrated through the redundantly included core concept when the same core concept is redundantly included in the first-stage networks, and FIG. 14 shows an embodiment of integrating the first-level networks through the relevancy when the core concepts included in different first-level networks are not the same but are related to each other. These first-level network integration methods may be collectively referred to as network projection.

First, the embodiment of FIG. 13 will be described. Referring to FIG. 13, a first-level network A 212 and a first-level network B 213 include a node 3 in common. In this case, when the first-level network A 212 and the second-level network B 213 are integrated through the node 3, which is included in common, the second-level network 221 is generated.

Next, the embodiment of FIG. 14 will be described. Referring to FIG. 14, the first-level network A 212 and the first-level network C 214 do not include the same node in common. However, it is assumed that node 3 of the first-level network A 212 and node 5 of the second-level network B 214 are related to each other as core concepts included in the same basic data (b, Doc 01). In this case, when the first-level network A 212 and the second-level network C 214 are integrated through the relevancy of the node 3 and the node 5, the second-level network 222 is generated as shown in FIG. 14.

In the second-level network 222 generated above, an edge (c) may be formed between the nodes 3 and 5 to indicate the relevancy between the nodes 3 and 5. The edge value at this time may vary depending on the relevancy between node 3 and node 5. Since ‘included in the same basic data’ is not a case of relatively high relevancy, an edge value of 0.1 is assigned here. On the other hand, here, as an example of the relevancy between nodes, ‘included in the same basic data’ is exemplified, but the scope of the present disclosure is not limited thereto. Other types of relevancy, such as ‘being studied by the same researcher’, etc., can also be used as a medium for first-level network integration.

FIG. 15 is a diagram for further describing step S130 of FIG. 8, and is a diagram conceptually illustrating a method of generating a third-level network by extending the depth of a second-level network. Here, the meaning of depth extension means adding a node corresponding to an upper core concept or lower core concept to the second-level network by searching the upper core concept or lower core concept on its ontology for a node in the second-level network. A network, to which an upper core concept or a lower core concept is added by depth extension, is defined as a third-level network.

Referring to the drawings for the detailed description, an example of the second-level network 223 is shown at the upper portion of FIG. 15. A total of five nodes, A-I, B-I, C-I, D-I, and E-I, exist in the second-level network 223. At this time, it is assumed that, through depth extension, A-I-a and A-I-b-i, which are lower core concepts, are searched for A-I node, C, which is an upper core concept, and C-I-a-i, which is a lower core concept, are searched for C-I node, and D, which is a upper core concept, is searched for D-I. When the searched upper core concept and lower core concept are added as new nodes to the second-level network 223, the third-level network 231 as shown in the lower portion of FIG. 15 is generated. In this case, the original node, that is, the node that originally existed in the second-level network, may be expressed in a different color to distinguish the original node and the node newly added by the depth extension.

Meanwhile, in this case, the depth extension may be performed based on a node, precisely a tree structure on an ontology of a core concept corresponding to a node. For example, to search the lower core concepts of the A-I node, the tree structure of the ontology is searched to identify that the lower core concepts A-I-a and A-I-b exist under the A-I core concept, and then identify that the lower core concept A-I-b-i exists under the A-I-b core concept. Adding the identified lower core concepts ‘A-I-a’ and ‘A-I-b-I’ within the core concept ‘A-I’ as shown in the third-level network 231 of FIG. 15 is an example of lower depth extension. Similarly, by searching the tree structure of the ontology to search the upper core concept of the C-I node, it can be identified that C exists as the upper core concept of the C-I core concept. However, in the case of an upper core concept, it can be simply identified what an upper core concept is by deleting the rear part of the core concept name, because the tree structure of the ontology is expressed in the core concept name itself. For example, by deleting the T at the rear part of the C-I core concept, it can simply derive C, which is an upper core concept. Adding the identified upper core concept ‘C’ outside the core concept ‘C-I’ as shown in the third-level network 231 of FIG. 15 is an example of upper depth extension.

FIGS. 16 to 27 are diagrams for describing a data processing process through specific embodiments in the third-level network generation method through the aforementioned depth extension. Hereinafter, it will be described with reference to the drawings.

FIG. 16 is a flowchart illustrating an embodiment, in which step S130 of FIG. 8 is further detailed. In the embodiment of FIG. 16, a case, in which upper core concepts are searched and added through depth extension, will be described.

In step S131, an upper core concept of a first core concept is identified when depth extension is performed among core concepts of a second-level network using the ontology or hierarchical information based on the tree structure of the ontology. In this case, the upper core concept of the first core concept may be identified by directly searching the tree structure of the ontology, or may be identified by simply deleting the rear part of the first core concept.

Here, the depth indicates how deep the corresponding core concept is from the root on the tree structure of the ontology, and the depth to perform the depth extension may be determined according to a predetermined criterion or a user selection. In this embodiment, it is exemplified that the depth of the uppermost core concept in each field is set to 0, and the depth increases by 1 every time the uppermost core concept goes down by one level. For example, if the first core concept is ‘Field01-A11-A-1-d,’ if the depth of the upper core concept to be searched is 2, the upper core concept is searched up to ‘Field01-A11-A-1,’ and if the depth of the upper core concept to be searched is 1, the upper core concept is searched up to ‘Field01-A11-A.’

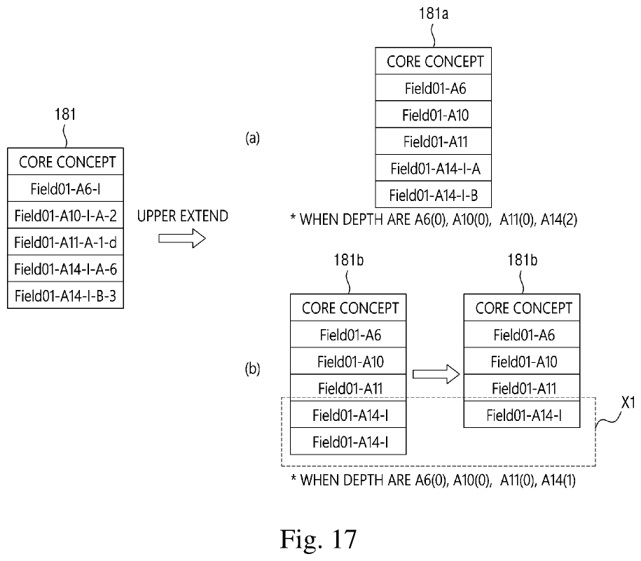

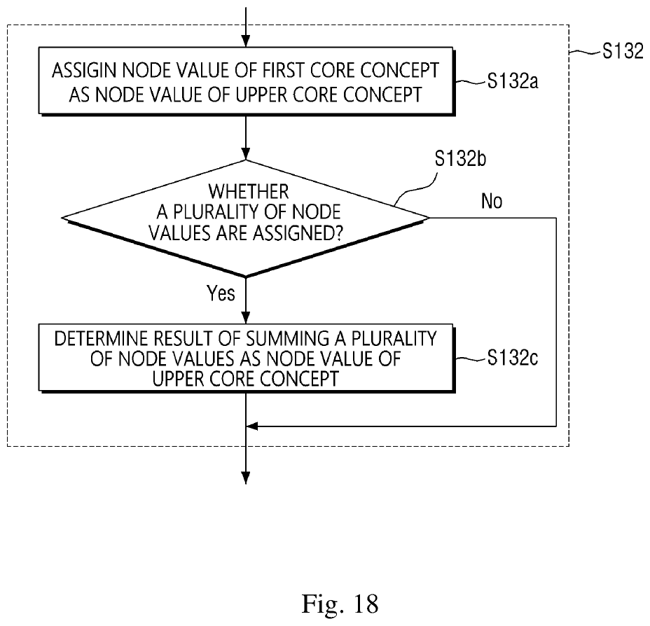

Step S132 is a step of determining the node value of the searched upper core concept, and the node value of the upper core concept is determined by using the node value of the first core concept. For example, the node value of the first core concept is assigned as the node value of the searched upper core concept, but when a plurality of node values are assigned to the upper core concept, the sum of all the node values may be determined as the node value of the upper core concept. A specific example of this is described in FIGS. 17 and 18.

In the left table 181 of FIG. 17, core concepts corresponding to the original node of the second-level network are indicated. In the right tables 181a and 181b, specific examples, in which the depth is extended to an upper core concept based on the core concepts in the left table 181, are displayed.

Among them, FIG. 17(a) is a case, in which the depth is extended to the depths of A6(0), A10(0), A11(0), and A14(2). FIG. 17 (b) is a case, in which the depth is extended to the depths of A6(0), A10(0), A11(0), and A14(1). Here, the number in parentheses means that the depth is extended to the depth of the number. For example, A6(0) means that ‘in the tree structure, core concepts with A6 as the uppermost core concept are extended to depth 0.’ By the same principle, A14(2) means that ‘in the tree structure, the core concepts with A14 as the uppermost core concept are extended to depth 2.’

Referring to FIG. 17(a), since the depths to be extended are A6(0), A10(0), A11(0), and A14(2), if the core concepts of the left table 181 are extended to a predetermined depth, the upper core concept is derived as shown in the table 181a at the upper right.

Similarly, looking at FIG. 17(b), since the depths to be extended are A6(0), A10(0), A11(0), and A14(1), the core concepts of the left table 181 are upper extended to a predetermined depth. Then, the upper core concept is derived as shown in the lower right table 181b. At this time, if the fourth and fifth core concepts of the left table 181 are extended to a predetermined depth, that is, to A14(1), the result is the same as ‘Field01-A14-I,’ As such, when the same upper core concept is redundantly derived as a result of depth extension, they are integrated into one (X1).

When a upper core concept to be added to the second-level network is derived through depth extension in this way, a node value and an edge value to be assigned to the upper core concept also should be determined.

FIG. 18 is a flowchart illustrating step S132 of FIG. 16, and a method of determining a node value to be assigned to a upper core concept is described.

In step S132a, the node value of the first core concept, which is the node of the second-level network, is assigned as the node value of the upper core concept.

In step S132b, it is determined whether a plurality of node values are assigned to the upper core concept. The fact that a plurality of node values are assigned to an upper core concept means that the same upper core concept was searched redundantly through depth extension.

If a plurality of node values are assigned to the upper core concept, the present embodiment proceeds to step S132c, and a result of summing the plurality of node values is determined as the node value of the upper core concept.

On the other hand, if only one node value is assigned to the upper core concept, the present embodiment skips step S132c.

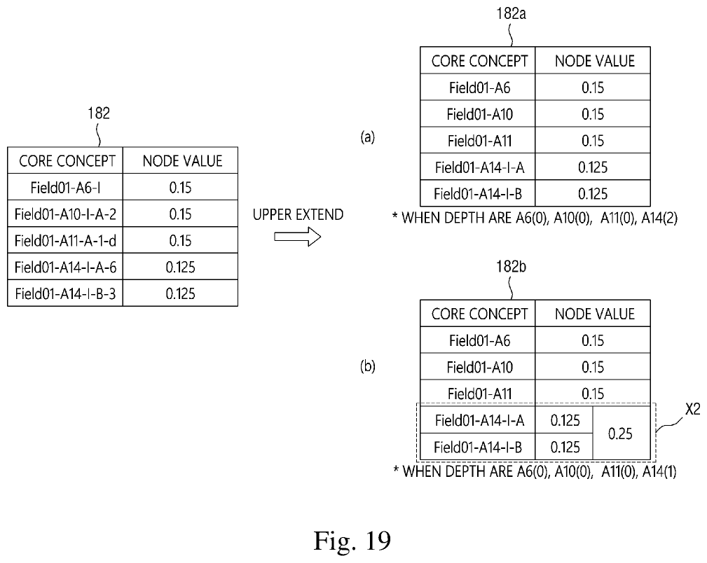

A specific example, to which the method of determining a node value described so far is applied, is shown in FIG. 19.

Referring to FIG. 19, in the left table 182, core concepts corresponding to the original nodes of the second-level network are displayed along with node values. In the right tables 182a and 182b, the result of depth extension to the upper level is shown when depths are A6(0), A10(0), A11(0), A14(2), and when depths are A6(0), A10(0), A11(0), A14(1), respectively. At this time, the node value of the original core concept is assigned to the upper core concept derived through the depth extension as it is. For example, looking at FIG. 19(a), it can be seen that the node value of the original core concept is assigned to the upper core concept as it is (182a).

On the other hand, as a result of the depth extension, the same upper core concept may be derived redundantly. Referring to FIG. 19 (b), it can be seen that the upper core concept ‘Field01-A14-I-A’ is redundantly derived as a result of extending the core concept ‘Field01-A14-I-A-6’ and the core concept ‘Field01-A14-I-B-3’ to the depth of A14(1). Accordingly, the node value 0.125 of the original core concept ‘Field01-A14-I-A-6’ and the node value 0.125 of ‘Field01-A14-I-B-3’ are assigned together to the upper core concept ‘Field01-A14-I-A.’ In this case, 0.25, which is the result of summing the assigned node values, is determined as the node value of the upper core concept ‘Field01-A14-I-A’ (X2).

Next, a method for determining the edge value assigned to the upper core concept will be described.

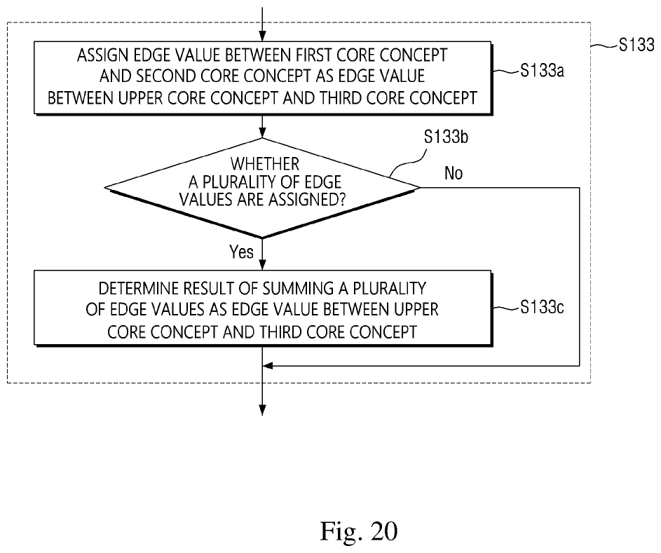

FIG. 20 is a flowchart illustrating step S133 of FIG. 16, and a method of determining an edge value to be assigned to an upper core concept is described.

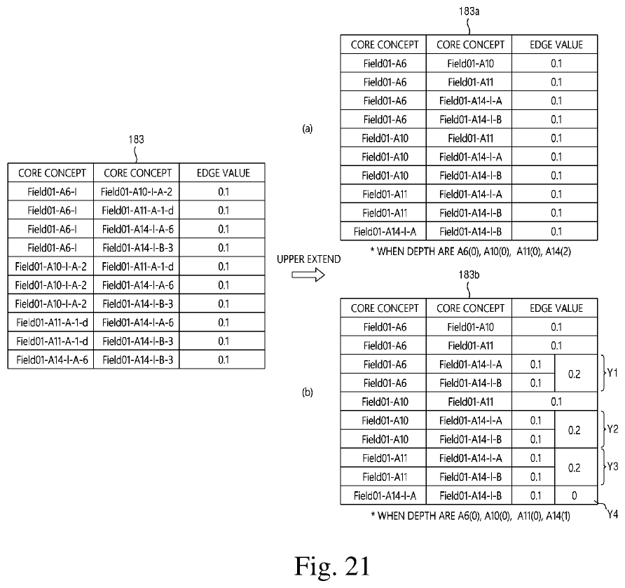

In step S133a, an edge value between the first core concept and the second core concept, which are nodes of the second-level network, is assigned as an edge value between the upper core concept and the third core concept. Here, the upper core concept is an upper core concept derived by depth extending the first core concept, and the third core concept may be the same as the second core concept or another upper core concept derived by depth extending the second core concept. The exact meaning of this part will be described later with reference to FIG. 21.

In step S133b, it is determined whether a plurality of edge values are assigned between the upper core concept and the third core concept. The fact that a plurality of edge values are assigned between the upper core concept and the third core concept means that the edge values are redundantly assigned to the same core concept pair by depth expansion.

If a plurality of edge values are assigned between the upper core concept and the third core concept, the present embodiment proceeds to step S133c, and the result of summing the plurality of edge values is determined as an edge value between the upper core concept and the third core concept.

On the other hand, if only one edge value is assigned between the upper core concept and the third core concept, the present embodiment skips step S133c.

A specific example, to which the edge value determination method described so far is applied, is shown in FIG. 21.

Referring to FIG. 21, in the left table 183, pairs of core concepts corresponding to original nodes of a second-level network are displayed along with edge values. The right tables 183a and 183b show the result of depth extension to the upper level when depths are A6(0), A10(0), A11(0), and A14(2), and when depths are A6(0), A10(0), A11(0), and A14(1), respectively.

In the first column of the right tables 183a and 183b, the result of depth extending the core concepts in the first column of the left table 183 is displayed. In the second column of the right tables 183a and 183b, the results of depth extending the core concepts in the second column of the left table 183 are displayed. The edge values in the third column of the left table 183 are displayed in the third column of the right tables 183a and 183b as they are. At this time, when pairs of core concepts in each row of the right tables 183a and 183b overlap with each other, the result of summing all the edge values assigned to the overlapped core concept pair is determined as the edge value of the overlapped core concept pair.

For example, referring to FIG. 21(a), since there is no overlapped core concept pair even after depth extension, edge values of the original core concept pair are assigned as they are.

On the other hand, referring to FIG. 21(b), the overlapped core concept pairs have emerged in the 3rd and 4th rows, 6th and 7th rows, and 8th and 9th rows of the table 183b after depth extension. In this case, if the edge values of the original core concept pair are assigned as they are, in the ‘Field01-A6’-′Field01-A144 pair, ‘Field01-A10’-‘Field01-A14-I’ pair, and ‘Field01-A11’-‘Field01-A14-I’ pair, two edge values are assigned redundantly, respectively. As mentioned above, the result of summing all the redundantly assigned edge values is determined as the final edge value of the core concept pair, here 0.2 (Y1, Y2, Y3).

Next, a case of depth extension to a lower core concept will be described.

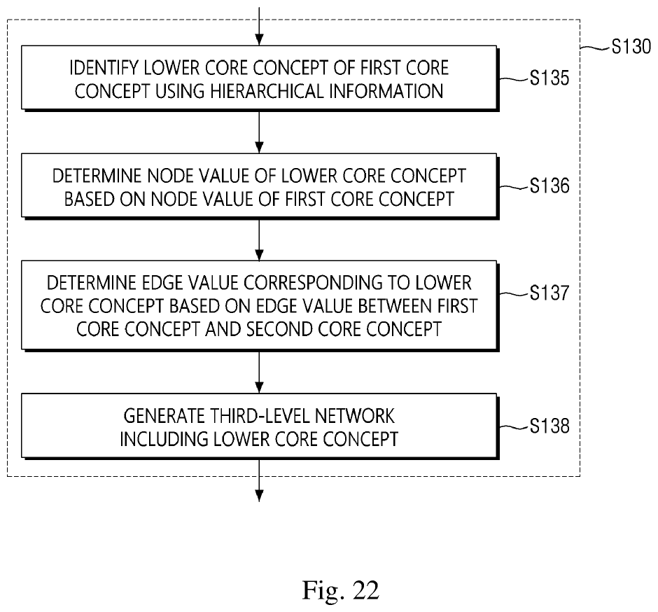

FIG. 22 is a flowchart illustrating an embodiment, in which step S130 of FIG. 8 is further detailed. In the embodiment of FIG. 22, a case, in which a lower core concept is searched and added through depth extension, will be described.

In step S135, a lower core concept of the first core concept, in which depth extension will be performed, among the core concepts of the second-level network is identified using the ontology or hierarchical information based on the tree structure of the ontology. At this time, the lower core concept of the first core concept is identified by searching the tree structure of the ontology.

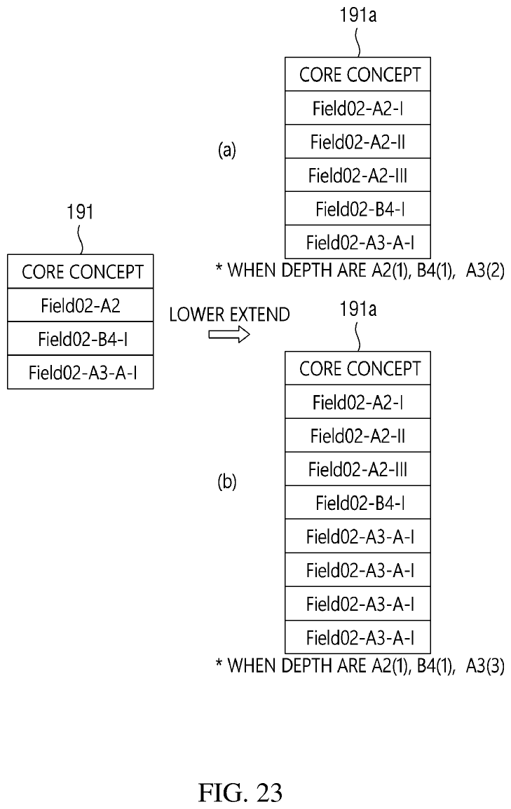

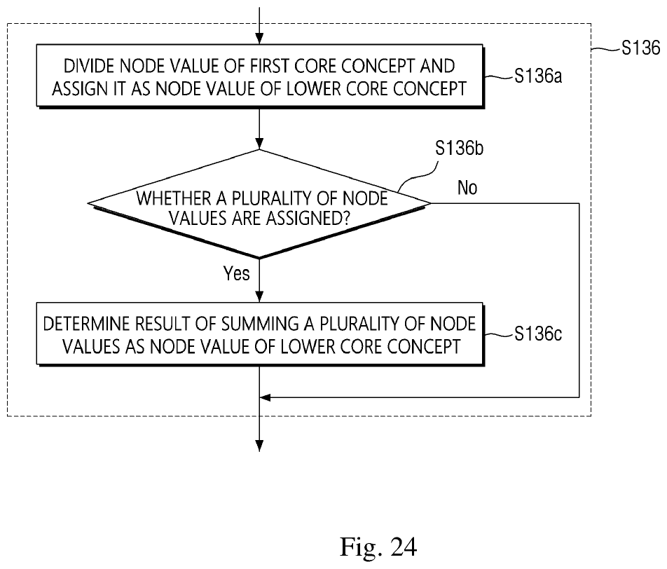

Step S136 is a step of determining the node value of the searched lower core concept, and the node value of the lower core concept is determined by using the node value of the first core concept. For example, the node value of the first core concept may be divided by the number of lower core concepts derived from the first core concept, and the resulting value may be assigned as the node value of the lower core concept. A specific example of this is described in FIGS. 23 and 24.

In the left table 191 of FIG. 23, core concepts corresponding to the original node of the second-level network are displayed. In the right tables 191a and 191b, specific examples, in which the core concepts of the left table 191 are depth extended to lower core concepts, are displayed.

Among them, FIG. 23(a) is a case, in which the depth extension is performed to the depths of A2(1), B4(1), and A3(2). FIG. 23 (b) is a case, in which the depth extension is performed to the depths of A2(1), B4(1), and A3(3).

Referring to FIG. 23(a), since the depths to be extended are A2(1), B4(1), and A3(2), if the core concepts of the left table 191 are depth extended to a predetermined depth, the lower core concepts are derived as shown in the upper right table 191a.

Similarly, looking at FIG. 23(b), since the depths to be extended are A2(1), B4(1), and A3(3), if the core concepts of the left table 191 are depth extended to a predetermined depth, the lower core concepts are derived as shown in the lower right table 191b.

However, here, it is presumed that, on the tree structure of the ontology, the three core concepts ‘Field02-A2-I,’ ‘Field02-A2-II,’ and ‘Field02-A2-III’ exist at the depth of A(2), one core concept ‘Field02-B4-I’ exists at the depth of B4(1), one core concept ‘Field02-A3-A-I’ exists at the depth of A3(2), and four core concepts ‘Field02-A3-AI-a,’ ‘Field02-A3-AI-b,’ ‘Field02-A3-AI-c,’ and ‘Field02-A3-AI-d’ exist at the depth of A3(3).

When a lower core concept to be added to the second-level network is derived through depth extension in this way, a node value and an edge value to be assigned to the lower core concept also should be determined.

FIG. 24 is a flowchart illustrating step S136 of FIG. 22, and a method of determining a node value to be assigned to a lower core concept is described.

In step S136a, the node value of the first core concept, which is a node of the second-level network, is divided and assigned as a node value of a lower core concept derived from the first core concept.

In step S136b, it is determined whether a plurality of node values are assigned to the lower core concept. The fact that a plurality of node values are assigned to a lower core concept means that the same lower core concept is redundantly searched through depth extension.

If a plurality of node values are assigned to the lower core concept, the present embodiment proceeds to step S136c, and a result of summing the plurality of node values is determined as the node value of the lower core concept.

On the other hand, if only one node value is assigned to the lower core concept, the present embodiment skips step S136c.

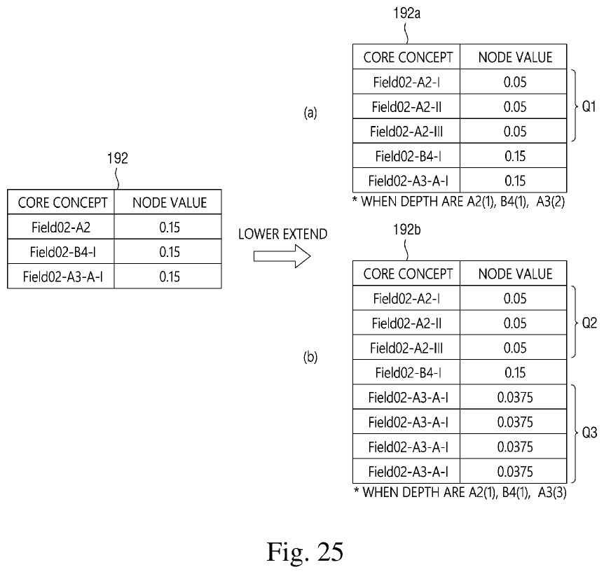

A specific example, to which the method of determining a node value described so far is applied, is shown in FIG. 25.

Referring to FIG. 25, in the left table 192, core concepts corresponding to the original nodes of the second-level network are displayed along with node values. In the right tables 192a and 192b, the result of depth extension to a lower level is shown when the depths are A2(1), B4(1), A3(2), and when the depth are A2(1), B4(1), A3(3), respectively. At this time, the node values of the original core concept are equally divided and assigned to the lower core concepts derived through the depth extension. For example, looking at (a) and (b) of FIG. 25, it can be seen that, for the lower core concepts ‘Field02-A2-I,’ ‘Field02-A2-II,’ and ‘Field02-A2-III’ derived from the original core concept ‘Field02-A2,’ the node value 0.15 of ‘Field02-A2’ is equally divided and 0.05 is assigned (Q1, Q2). Similarly, it can be seen that, for the lower core concepts ‘Field02-A3-AI-a,’ ‘Field02-A3-AI-b,’ ‘Field02-A3-AI-c’ derived from the original core concept ‘Field02-A3-A-I,’ the node value 0.15 of ‘Field02-A3-A-I’ is equally divided and 0.0375 is assigned (Q3).

In the example of FIG. 25, since the lower core concepts are not duplicated according to the depth extension, the case where the final node value is obtained by summing node values redundantly assigned to one lower core concept is not shown.

Next, a method for determining the edge value assigned to a lower core concept is described.

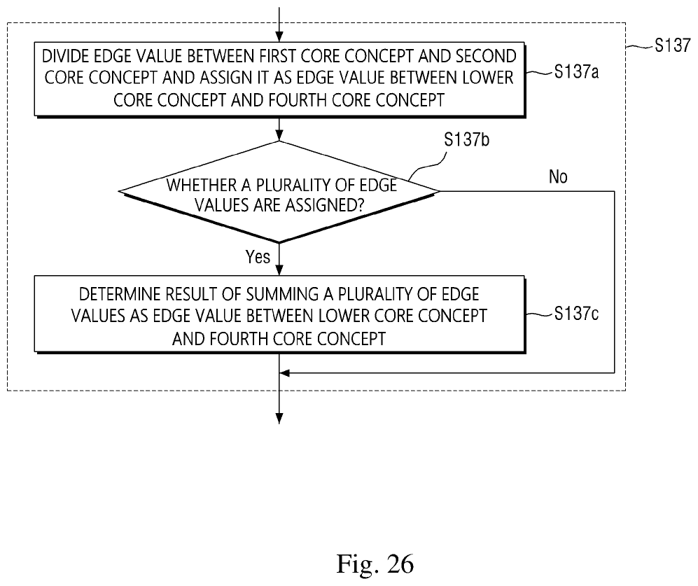

FIG. 26 is a flowchart illustrating step S137 of FIG. 22, and a method of determining an edge value to be assigned to a lower core concept is described.

In step S137a, the edge value between the first core concept and the second core concept, which are nodes of the second-level network, is divided according to the number of lower core concept pairs derived therefrom and assigned as an edge value between the lower core concept and the fourth core concept. Here, the lower core concept may be a lower core concept derived by the depth extension of the first core concept, and the fourth core concept may be the same as the second core concept or another lower core concept derived by depth extension of the second core concept. The exact meaning of this part will be described later with reference to FIG. 26.

In step S137b, it is determined whether a plurality of edge values are assigned between the lower core concept and the fourth core concept. The fact that a plurality of edge values are assigned between the lower core concept and the fourth core concept means that the edge values are redundantly assigned to the same core concept pair by depth extension.

If a plurality of edge values are assigned between the lower core concept and the fourth core concept, the present embodiment proceeds to step S137c, and the result of summing the plurality of edge values is determined as an edge value between the lower core concept and the fourth core concept.

On the other hand, if only one edge value is assigned between the lower core concept and the fourth core concept, the present embodiment skips step S137c.

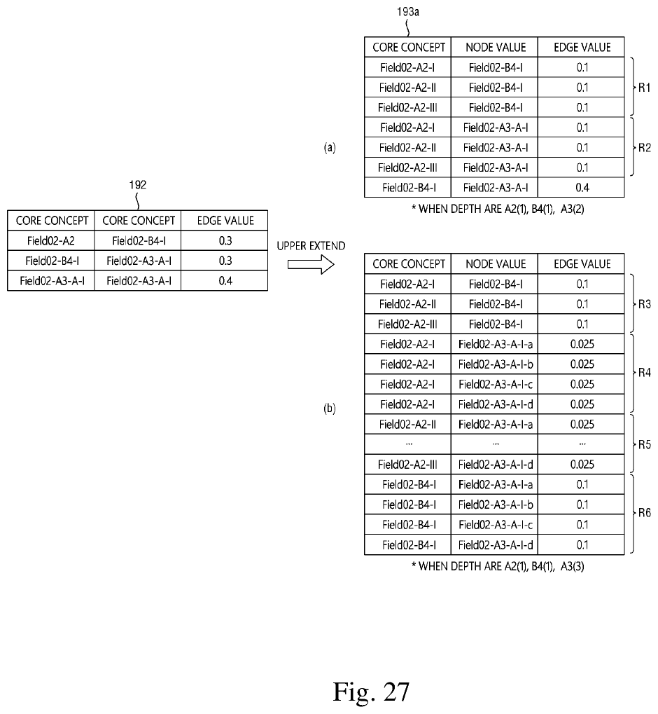

A specific example, to which the edge value determination method described so far is applied, is shown in FIG. 27.

Referring to FIG. 27, in the left table 193, a pair of core concepts corresponding to an original node of a second-level network is displayed along with an edge value. In the right tables 193a and 193b, the result of depth extension to the lower level is shown when the depths are A2(1), B4(1), A3(2), and when the depths are A2(1), B4(1), A3(3), respectively.

In the right tables 193a and 193b, when each of core concepts in the left table 193 is depth extended to a lower level, core concept pairs that can be derived therefrom are displayed.

For example, referring to FIG. 27(a), when ‘Field02-A2’ of the left table 193 is extended to the depth of A2(1), three lower core concepts of ‘Field02-A2-I’, ‘Field02-A2-II,’ ‘Field02-A2-III’ are derived. But, ‘Field-2-B4-I’ and ‘Field02-A3-A-I’ have the depth of the original core concepts of B4(1), A3(2), so no additional lower core concepts are derived from it. Accordingly, in this case, the pair of core concepts derivable through the lower extension becomes the same as the table 193a on the upper right portion.

In this case, the edge value assigned to each core concept pair is a value obtained by dividing the edge value between the original core concepts in the left table 193 by the number of core concept pairs derived through depth extension. For example, in the left table 193, the edge value assigned to the pair ‘Field02-A2’-‘Field02-B4-I’ is 0.3, and three core concept pairs of ‘Field02-A2-I’-‘Field02-B4-I,’ ‘Field02-A2-II’-‘Field02-B4-I,’ and ‘Field02-A2-III’-‘Field02-B4-I’ were derived through the lower extension therefrom. Thus, each of the core concept pairs ‘Field02-A2-I’-‘Field02-B4-I’, ‘Field02-A2-II’-‘Field02-B4-I’, and ‘Field02-A2-III’-‘Field02-B4-I’ derived through lower extension is assigned an edge value of 0.1, which is obtained by dividing the edge value of the original core concept pair ‘Field02-A2’-‘Field02-B4-I’ by 3 (R1).

In a similar way, each of the core concept pairs derived by the lower extension of ‘Field02-A2’-‘Field02-A3-A-I’ pair in the left table 193 is assigned an edge value of 0.1, which is obtained by dividing the edge value of the original core concept pair of ‘Field02-A2’-‘Field02-A3-A-I’ by 3 (R2).

In FIG. 27(b), edge values are assigned in a similar manner. For example, for the ‘Field02-A2’-‘Field02-B4-I’ pair of the left table 193, an edge value of 0.1 is assigned to each of the core concept pairs derived through the lower extension in the same way as in the case of FIG. 27(a) (R3).

On the other hand, for the ‘Field02-A2’-‘Field02-A3-A-I’ pair of the left table 193, in the case of FIG. 27(b), since ‘Field02-A3-A-I’ derives the four lower core concepts, a total of 12 core concept pairs are derived from the ‘Field02-A2’-‘Field02-A3-A-I’ pair as shown. Thus, each of the core concept pairs derived from the ‘Field02-A2’-‘Field02-A3-A-I’ pair is assigned 0.025 as the edge value, which is obtained by dividing the edge value of ‘Field02-A2’-‘Field02-A3-A-I,’ 0.3 by 12 (R4, R5).

Since the ‘Field02-B4-I’-‘Field02-A3-A-I’ pair in the left table 193 also derives four core concept pairs from it, each of the core concept pairs derived from ‘Field02-A2’-‘Field02-A3-A-I’ pair is assigned 0.1 as the edge value, which is obtained by dividing the original edge value of 0.4 by 4 (R6).

In the above, methods for generating a third-level network by depth extending a second-level network have been described. The depth extension method used here is defined as a depth combination method. On the other hand, in the above embodiments, the case of the upper extension and the case of the lower extension have been separately described, but this is only divided for convenience for clarity and simplicity of the description, and the scope of the present disclosure is not limited thereto. That is, in the depth extension, the upper extension and the lower extension can be applied at the same time, which is closer to the general case.

Hereinafter, an embodiment of updating a third-level network using additional information will be described.

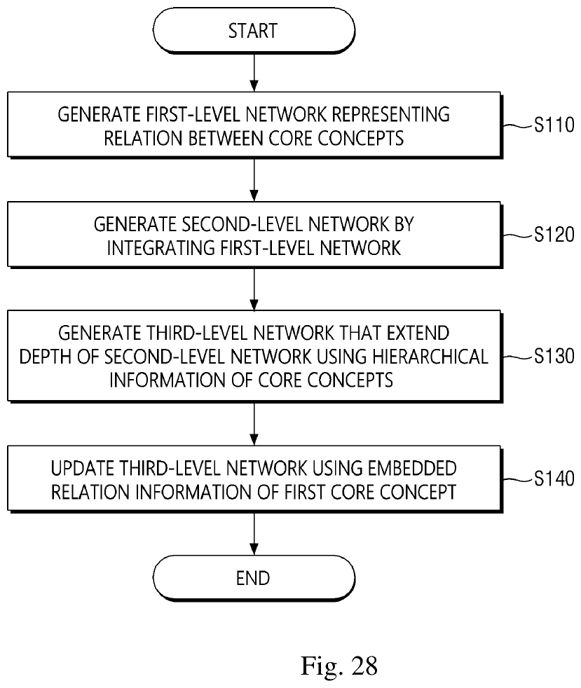

FIG. 28 is a flowchart illustrating an embodiment of updating a third-level network by using embedded relation information between core concepts. The flowchart of FIG. 28 is mostly similar to the flowchart of FIG. 8. However, the difference is that the step S140 is further included after the step S130.

In FIG. 28, steps S110 to S130 are substantially the same as those described in FIG. 8, and thus descriptions thereof will be omitted here to avoid duplication of description.

In step S140, the third-level network is updated using embedded relation information of core concepts included in the third-level network.

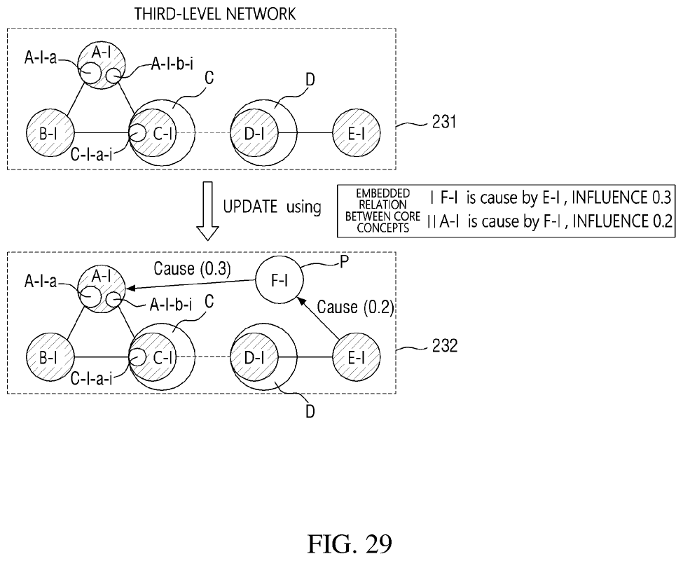

The embedded relation information described herein is the same as the embedded relation information between the core concepts described in FIGS. 5A to 5D, and means information that can be naturally inferred by inferring the embedded meaning of the core concepts belonging to the ontology. A specific example of updating the third-level network using the embedded relation information will be described with reference to FIG. 29.

In the upper portion of FIG. 29, a third-level network 231 that extends the depth of the core concepts is shown. A node marked with hatching means an original node, and a node without hatching means a node added through depth extension.

At this time, it is assumed that there is embedded relation information that the ‘F-I’ node is caused by ‘E-I’ and the influence at that time is 0.3, and the ‘A-I’ node is caused by ‘F-I’ and the influence at that time is 0.2.

When the above embedded relation information is reflected in the third-level network 231, as shown in the lower portion of FIG. 29, the third-level network 232 may be updated so that a node P corresponding to the core concept ‘F-I’ is added in the third-level network 232, the edge from the ‘E-I’ node toward the ‘F-I’ node is connected between the ‘E-l’ node and the ‘F-I’ node, and the edge value at that time is 0.2. At the same time, the relation between the ‘A-I’ node and the ‘F-I’ node is also added, and the third-level network 232 may be updated so that the edge from the ‘F-I’ node toward the ‘A-I’ node is connected between the ‘A-I’ node and the ‘F-I’ node and the edge value at that time is 0.3.

On the other hand, at this time, the relation between the ‘F-I’ node and the ‘E-I’ node, and the ‘F-I’ node and the ‘A-I’ node is a cause-and-result relation, in which direction exists. Thus, ‘Cause’ information may be added to the edges between the ‘F-I’ node and the ‘E-I’ node, and the ‘F-I’ node and the ‘A-I’ node in order to know the nature of such a relation.

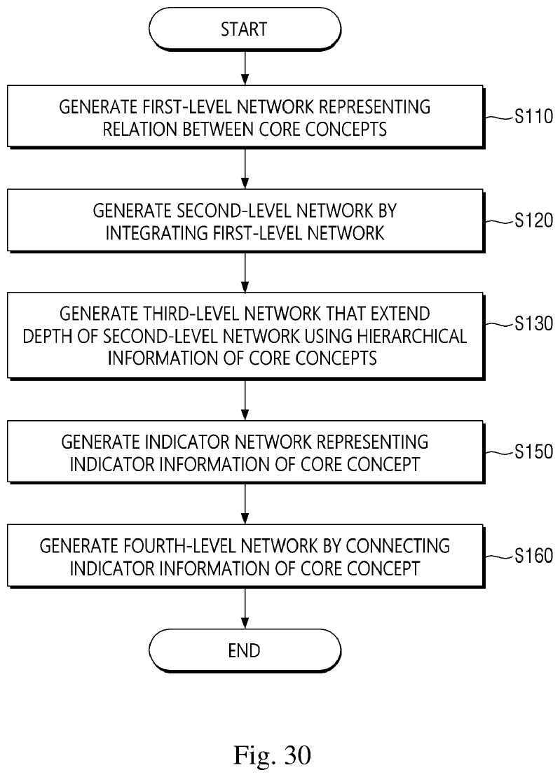

FIG. 30 is a flowchart illustrating an embodiment of updating a third-level network using indicator information of core concepts. The flowchart of FIG. 30 is mostly similar to the flowchart of FIG. 8. However, the difference is that steps S150 and S160 are further included after step S130.

In FIG. 30, steps S110 to S130 are substantially the same as those described in FIG. 8, and thus a description thereof will be omitted here to avoid duplication of description.

In step S150, an indicator network representing indicator information of core concepts is generated. Here, the indicator network refers to a data type, in which the indicator information described above with reference to FIGS. 3 to 7 is organized together with related indicator attributes.

In step S160, a fourth-level network is generated by connecting the indicator information or indicator network of core concepts to the second-level network or the third-level network. In the fourth-level network generated through this, not only the relevancy between core concepts but also the indicator information of individual core concepts are integrated into one network.

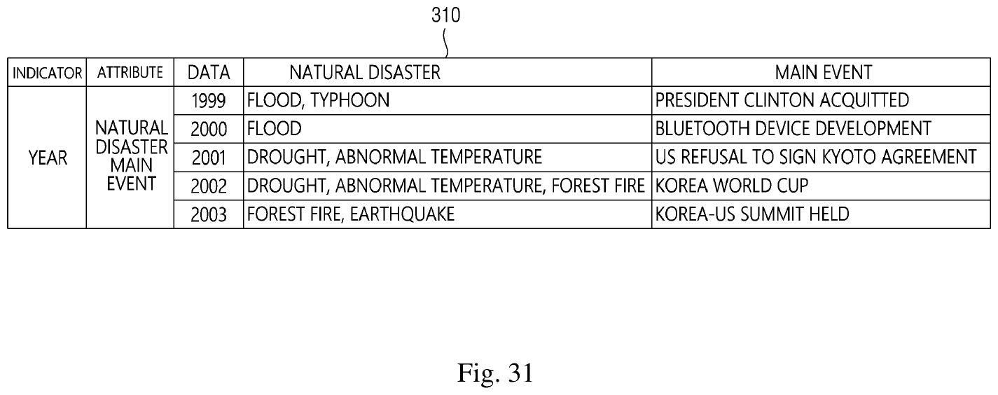

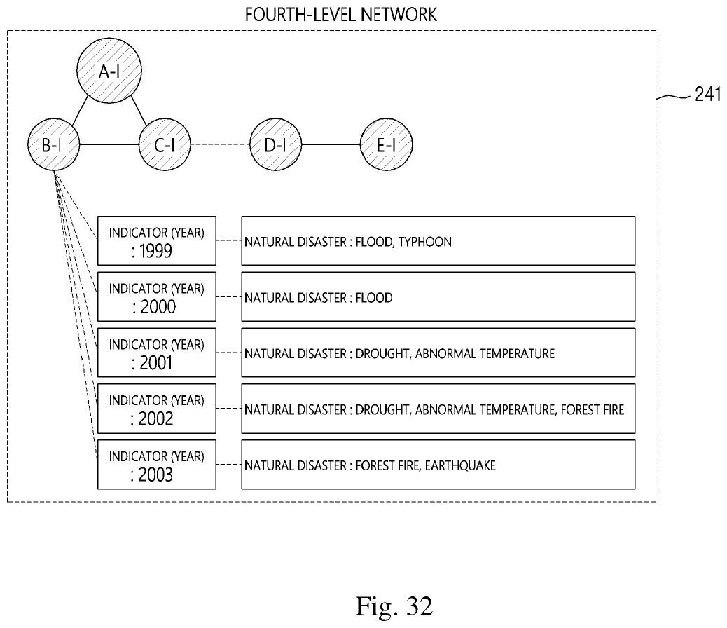

The method of generating the fourth-level network described here will be described with reference to FIGS. 31 to 32 with specific examples.

FIG. 31 is a diagram illustrating an exemplary form of an indicator network. Referring to FIG. 31, an indicator network 310, in which attribute information is organized for the year indicator, is shown. According to the indicator network 310 of FIG. 31, there are two attributes of ‘natural disaster’ and ‘main event’ for the year indicator, and information on the two attributes is organized according to individual year data.

FIG. 32 shows an example of connecting an indicator network to a second-level network. Referring to FIG. 32, the indicator network 310 of FIG. 31 is connected to the ‘B-I’ node of the second-level network 241 to display attribute information according to year. At this time, the fact that the indicator (year) network is connected to the ‘B-I’ node means that the shown natural disasters occurred in the year in relation to the core concept ‘B-I.’

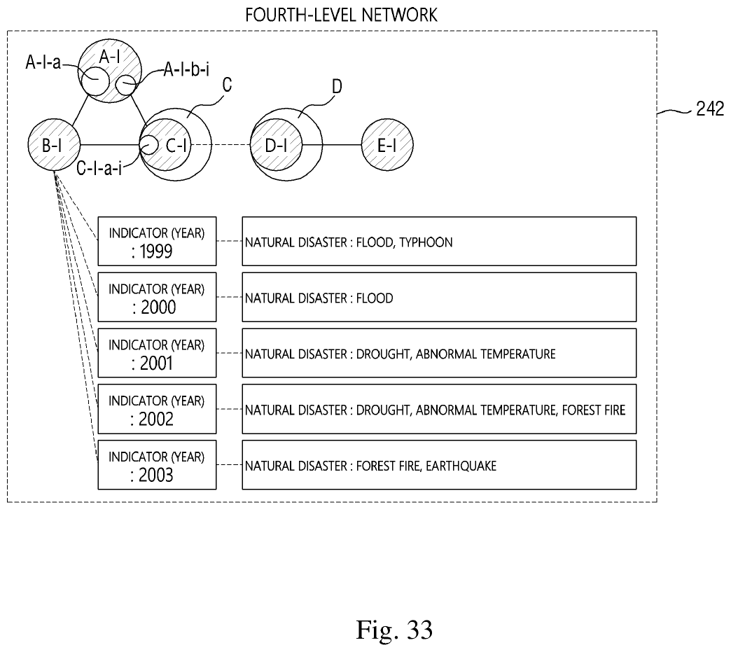

FIG. 33 shows an example of connecting an indicator network to a third-level network. Except for the fact that the indicator network is connected to the third-level network 242, other contents are substantially the same as those described in FIG. 32.

Method of Responding to a User Query Based on the Constructed Database

Hereinafter, a method of responding to a user query for a global problem based on the database constructed according to the method described above will be described.

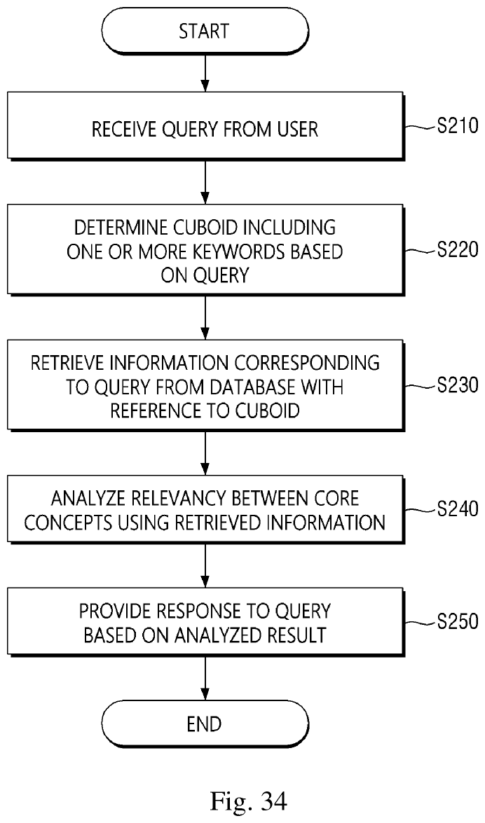

FIG. 34 is a flowchart illustrating a method for responding to a user query according to an embodiment of the present disclosure. In FIG. 34, an embodiment of responding to a user query by determining a cuboid for searching information from a user query after receiving the user query, and analyzing the relevancy between core concepts based on the determined cuboid is described.

In step S210, a query is received from the user. The user query may be received in the form of text, voice, scanned image, video clip, radio wave, or other electrical signals.

In step S220, after the main keyword is extracted from the received user query, a cuboid is determined based on the extracted keyword. In this case, the main keyword may be a word related to a core concept, indicator information, or category among words included in the user query. When a keyword is extracted, a cuboid is determined by a combination of the extracted keywords.

In step S230, with reference to the determined cuboid, information corresponding to the user query is retrieved from the previously constructed database. For example, if ‘China’ and ‘agriculture’ are extracted as keywords from a user query, a cuboid combining these two keywords is determined. At this time, since ‘China’ is a word corresponding to the category, it is filtered to select only ‘China’ related data from the database by the ‘China’ keyword of the cuboid. And, since ‘agriculture’ is a word corresponding to a core concept, the core concept of ‘agriculture,’ the core concept directly or indirectly connected thereto, and related indicator information are retrieved from the previously selected ‘China’ related data by the ‘agriculture’ keyword of the cuboid.

In step S240, the relevancy between core concepts is analyzed using the retrieved information. In this case, the relevancy between the core concepts may be analyzed based on the meaning of the core concepts, a node value, an edge value, a relation between the core concepts, indicator information, a domain, a dimension, or an analysis method.

In step S250, a response to the user query is generated based on the analyzed result. As an embodiment, the response may express the meaning of the previously analyzed core concepts, node values, edge values, relation between core concepts, indicator information, a domain, a dimension, or an analysis method in language morphemes, and then be composed in the form of a sentence by a combination of these.

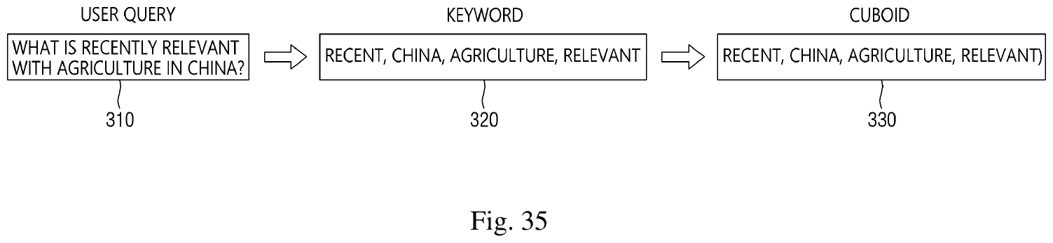

FIGS. 35 to 39 shows the response method described with reference to FIG. 30 with the specific examples.

FIG. 35 illustrates an example method for determining a cuboid from a user query. Referring to FIG. 35, first, a user query 310 of ‘What is recently relevant with agriculture in China?’ is received.

Next, words related to the core concept, category, indicator information, domain, or dimension of the database are extracted as keywords 320 from the received user query 310. Here, it is assumed that ‘China’ as a category related to a region, ‘recent’ as a category related to a year, ‘agriculture’ as a core concept, and ‘relevant’ as an analysis method are extracted as keywords 320.

When the keywords 320 are extracted, the cuboids 330 for database retrieval are determined by combining them. Most simply, the cuboid 330 may be configured in a form, in which all extracted keywords are combined.

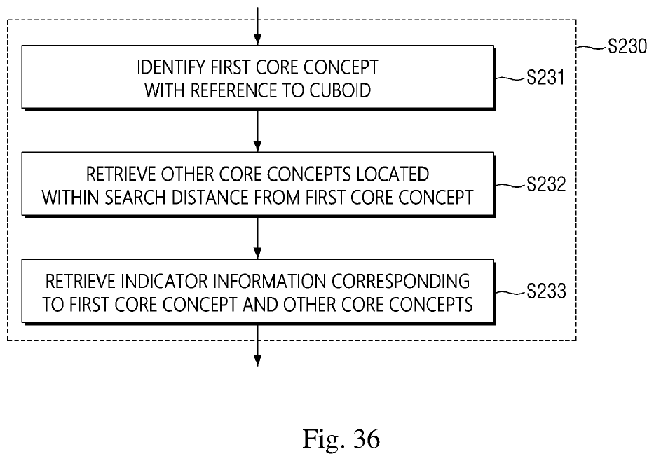

FIG. 36 is a flowchart illustrating step S230 of FIG. 34, and describes a specific example of retrieving information based on a cuboid after it is determined. Hereinafter, it will be described with reference to the drawings.

In step S231, a first core concept that is a search target is identified with reference to the cuboid. Referring to the example of FIG. 35 above, after only recent data related to China is selected by category keywords ‘China’ and ‘recent,’ the core concept ‘agriculture’ is identified as the first core concept therein.

In step S232, other core concepts located within a search distance from the first core concept are retrieved. In order to analyze the first core concept, other core concepts related to the first core concept should be retrieved and analyzed together. However, in the database according to the present disclosure, since each node is directly or indirectly connected to each other very widely, too much data is retrieved if the retrieval range is not limited. This is undesirable in terms of efficiency of analysis or utilization of computing resources. Therefore, the retrieval range is limited to retrieve only those located within a predetermined search distance from the first core concept.

In step S233, if the first core concept and other core concepts related thereto are retrieved, indicator information corresponding to the first core concept and other core concepts is retrieved. This is to improve the quality of analysis results by additionally retrieving and analyzing indicator information related to core concepts.

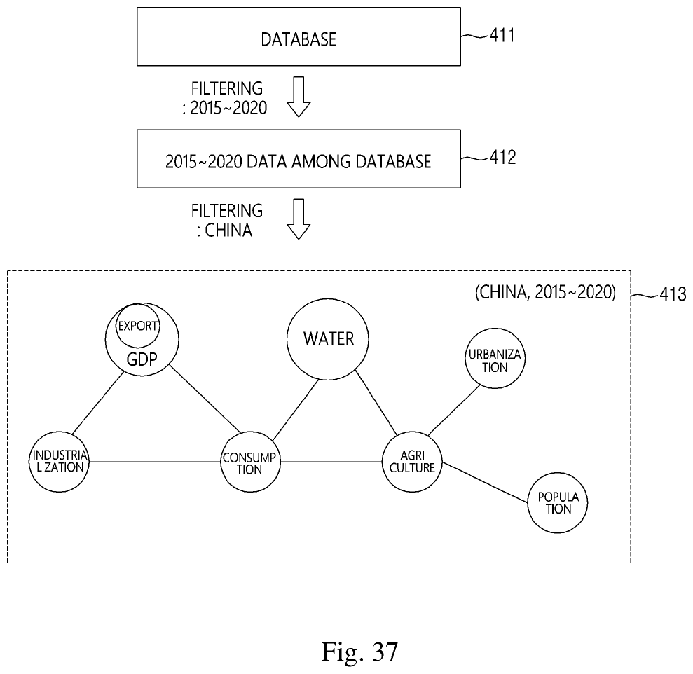

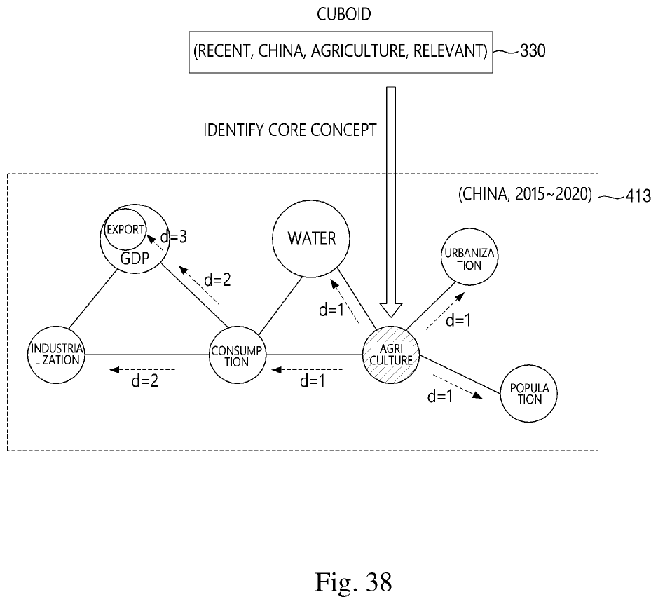

The retrieval method described with reference to FIG. 36 will be described in more detail with reference to FIGS. 37 and 38.

FIG. 37 illustrates a method of selecting data in a database using category keywords. Referring to FIG. 37, first, only data from 2015 to 2020 are selected by the category ‘recent’ in the database 411. However, matching ‘recent’ to the period from 2015 to 2020 is merely an example, and it is possible to match other periods for ‘recent.’

And, among the selected data 412 from 2015 to 2020, only China-related data is selected again by the category ‘China.’ An exemplary form 413 of data finally selected in this way is shown at the lower portion of FIG. 37.

FIG. 38 illustrates a method of retrieving specifically necessary information from data after data is selected by category. Referring to FIG. 38, the first core concept (G), which is a search target, is identified from the finally selected data 413 with reference to the keyword ‘agriculture’ of the cuboid 330. Then, the identified first core concept or other core concepts located within the search distance (d) from the node (G) corresponding thereto are retrieved.

For example, if the search distance is 1 (d=1), only water, consumption, urbanization, and population directly connected to the agriculture node (G) by the edge are retrieved. Alternatively, if the search distance is 2 (d=2), in addition to water, consumption, urbanization, and population, industrialization and GDP indirectly connected to the agriculture node (G) are further retrieved. Alternatively, if the search distance is 3 (d=3), in addition to water, consumption, urbanization, population, industrialization, and GDP, export that goes one level deeper than GDP is further retrieved.

When other core concepts related to agriculture are retrieved according to the search range, indicator information corresponding to the agriculture and the other core concepts is further retrieved, and then it may be stored in a separate memory space or storage space used to analyze the correlation between core concepts centered on agriculture.

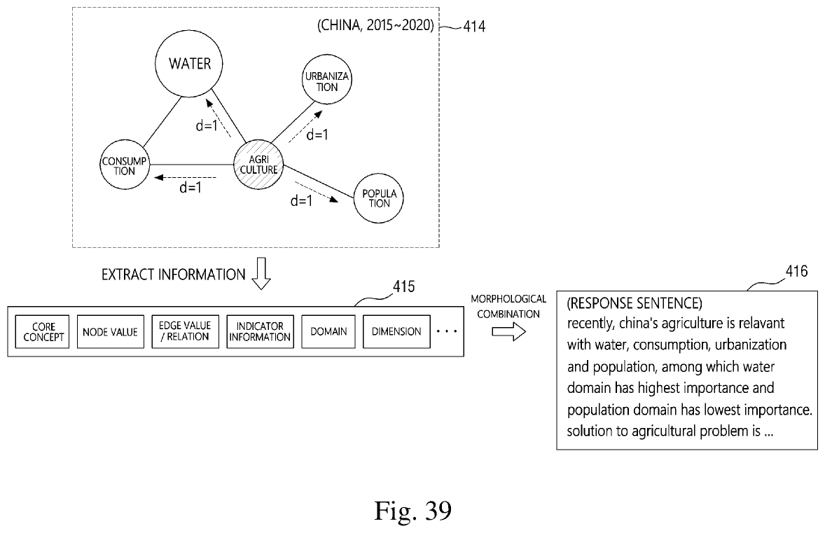

FIG. 39 is a view for describing a specific example of outputting a response to a user query in the form of a sentence. When the analysis target data 414 is finally retrieved by the method described above in FIG. 38, information necessary for analysis is extracted therefrom.

The information extracted at this time may include information such as the meaning of retrieved first core concept and other core concepts, node values, edge values, relation between the first core concept and other core concepts, indicator information corresponding to the first core concept and other core concepts, domains, or dimensions.

Then, after converting the extracted information into language morphemes corresponding thereto, the converted language morphemes are combined to generate a response sentence to the user query. For example, referring to the extracted information, it can be seen that agriculture is related to water, consumption, urbanization, and population because agriculture is connected to them by the edge. Furth, it can be seen that among them, water with the largest node value has the highest importance, and the population with the smallest node value has the lowest importance. Also, if the dimension of water among the extracted core concepts is a ‘scientific solution,’ it can be seen that water is related to the solution of agricultural problems. A response sentence 416 expressed in a natural language as shown in FIG. 39 may be generated by combining the analysis results after morphologicalizing them through natural language processing.

The generated response sentence 416 is provided to the user in response to the user query.

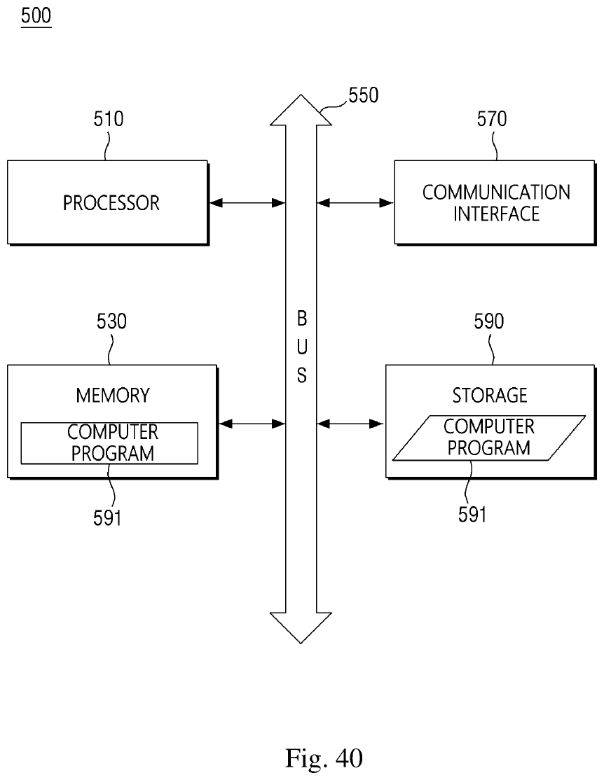

FIG. 40 is an example hardware diagram illustrating a computing device 500.

As shown in FIG. 40, the computing device 500 may include one or more processors 510, a bus 550, a communication interface 570, a memory 530, which loads a computer program 591 executed by the processors 510, and a storage 590 for storing the computer program 591. However, FIG. 40 illustrates only the components related to the embodiment of the present disclosure. Therefore, it will be appreciated by those skilled in the art that the present disclosure may further include other general purpose components in addition to the components shown in FIG. 40.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. For example, when the computer program 591 is loaded into the memory 530, the logic (or the module) as shown in FIG. 8, FIG. 28, FIG. 30 and FIG. 34 may be implemented on the memory 530. An example of the memory 530 may be a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present disclosure are implemented. When the computer program 591 is loaded on the memory 530, the processor 510 may perform the methods/operations in accordance with various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device. Although the operations are shown in a specific order in the drawings, those skilled in the art will appreciate that many variations and modifications can be made to the preferred embodiments without substantially departing from the principles of the present inventive concept. Therefore, the disclosed preferred embodiments of the invention are used in a generic and descriptive sense only and not for purposes of limitation. The scope of protection of the present inventive concept should be interpreted by the following claims, and all technical ideas within the scope equivalent thereto should be construed as being included in the scope of the technical idea defined by the present disclosure.

What is claimed is:

1. A method performed by a computing device for constructing a database based on an ontology comprises:
generating a first-level network representing a relation between core concepts based on a data frame;
generating a second-level network by integrating the first-level network with another first-level network; and
generating a third-level network that extends a depth of the second-level network by using hierarchical information of the core concepts,
wherein the hierarchical information is based on a predetermined ontology.

2. The method of claim 1, wherein generating the first-level network comprises, extracting a first core concept and a second core concept from an item of the data frame;
calculating node values of the first core concept and the second core concept;
calculating an edge value between the first core concept and the second core concept; and
generating the first-level network based on the node values and the edge value.

3. The method of claim 2, wherein the node values indicate importance of the first core concept and the second core concept within the item.

4. The method of claim 2, wherein the edge value indicates a degree of relevancy between the first core concept and the second core concept within the item.

5. The method of claim 1, wherein generating the second-level network comprises,
integrating the first-level network and another first-level network based on relevancy between a first core concept of the first-level network and a third core concept of another first-level network.

6. The method of claim 1, wherein generating the third-level network comprises,
identifying an upper core concept of a first core concept among the core concepts by using the hierarchical information;
determining a node value of the upper core concept based on a node value of the first core concept; and
determining an edge value corresponding to the upper core concept based on an edge value between the first core concept and a second core concept.

7. The method of claim 6, wherein determining a node value of the upper core concept comprises,
assigning a node value of the first core concept as a node value of the upper core concept.

8. The method of claim 7, wherein determining a node value of the upper core concept further comprises,
determining, in response to a plurality of node values being assigned to the upper core concept by depth extending the second-level network, a result of summing the plurality of node values as a node value of the upper core concept.

9. The method of claim 6, wherein determining an edge value corresponding to the upper core concept comprises,
assigning an edge value between the first core concept and the second core concept as an edge value between the upper core concept and a third core concept.

10. The method of claim 9, wherein determining an edge value corresponding to the upper core concept further comprises,
determining, in response to a plurality of edge values being assigned between the upper core concept and the third core concept by depth extending the second-level network, a result of summing the plurality of edge values as an edge value between the upper core concept and the third core concept.

11. The method of claim 1, wherein generating the third-level network comprises,
identifying a lower core concept of a first core concept among the core concepts by using the hierarchical information;
determining a node value of the lower core concept based on a node value of the first core concept; and
determining an edge value corresponding to the lower core concept based on an edge value between the first core concept and the second core concept.

12. The method of claim 11, wherein determining a node value of the lower core concept comprises,
dividing a node value of the first core concept and assigning it as a node value of the lower core concept.

13. The method of claim 11, wherein determining a node value of the lower core concept further comprises,
determining, in response to one or more node values being assigned to the lower core concept by depth extending the second-level network, a node value of the lower core concept by summing the one or more node values.

14. The method of claim 11, wherein determining an edge value corresponding to the lower core concept comprises,
dividing an edge value between the first core concept and the second core concept and assigning it as an edge value between the lower core concept and a fourth core concept.

15. The method of claim 1 further comprises,
updating the third-level network by using embedded relation information of a first core concept among the core concepts.

16. The method of claim 1 further comprises,
generating a fourth-level network by connecting indicator information of the core concepts to the second-level network or the third-level network.

17. The method of claim 1 further comprises,
generating an indicator network representing indicator information of the core concepts.

18. A system for constructing a database based on an ontology comprising:
a processor;
a memory for loading a computer program executed by the processor; and
a storage for storing the computer program,
wherein the computer program comprises instructions for performing operations comprising,
generating a first-level network representing a relation between core concepts based on a data frame;
generating a second-level network by integrating the first-level network with another first-level network; and
generating a third-level network that extends a depth of the second-level network by using hierarchical information of the core concepts,
wherein the hierarchical information is based on a predetermined ontology.
